(19) United States
(12) Patent Application Publication
(10) Pub. No.: US 2021/0027226 A1
(43) Pub. Date: Jan. 28, 2021

(54) Enterprise manufacturing inventory management system and method

(71) Applicant: Stephen Carroll Mohun, Alamo, CA (US)

(72) Inventor: Stephen Carroll Mohun, Alamo, CA (US)

(21) Appl. No.: 17/062,187

(22) Filed: Oct. 2, 2020

Related U.S. Application Data
(63) Continuation-in-part of application No. 15/461,439, filed on Mar. 16, 2017.
(60) Provisional application No. 62/390,047, filed on Mar. 17, 2016.

(51) Int. Cl. G06Q 10/06; G06Q 10/08; G06Q 50/04; G06Q 40/00

(52) U.S. Cl. CPC G06Q 10/06313; G06Q 10/0875; G06Q 40/12; G06Q 50/04; G06Q 10/06312

(57) ABSTRACT

A system for enterprise performance management includes an enterprise performance management server, including a processor, a non-transitory memory, an input/output, an account aggregation manager, an account planning manager, an activity id correlation table, and activity id connectivity table with an account calculation procedure, a planning account overview table; an enterprise performance management device; an inventory procurement system; and a plurality of enterprise resource planning/accounting systems with general ledgers, such that the system creates an aggregated chart of activity accounts, each activity account comprising an activity id and associated aggregated planned cost, aggregated actual cost, and aggregated forecasted quantity, which aggregates general ledger accounts. The aggregated forecasted quantity can be used for centralized purchasing via the inventory procurement system. The account planning manager processes updates of aggregated planned cost and automatically updates aggregated planned cost of interconnected activity accounts.

### CROSS-REFERENCE TO RELATED APPLICATIONS

This U.S. Non-Provisional application is a Continuation-In-Part of U.S. Non-Provisional application Ser. No. 15/461,439, filed Mar. 16, 2017, which claims the benefit of U.S. Provisional Application No. 62/390,047, filed Mar. 17, 2016; both of which are hereby incorporated herein by reference in their entirety.

### FIELD OF THE INVENTION

The present invention relates generally to the field of enterprise management, and more particularly to methods and systems for enterprise performance management.

### BACKGROUND OF THE INVENTION

Enterprise software systems are typically sophisticated systems that support multiple concurrent users. Examples of enterprise software systems include enterprise resource planning systems (ERP), enterprise performance management systems (EPM) and corporate performance management systems (CPM), strategic corporate performance management systems (SCPM), financial corporate performance management systems (FCPM), financial planning systems, order management systems, inventory management systems, sales force management systems, business intelligence tools, enterprise reporting tools, project and resource management systems and other enterprise software systems.

Many ERP, EPM, CPM, SCPM, FCPM and business planning software systems require a large population of users to submit data that the software systems then accumulate into higher level areas of responsibility in the organization. The software systems may perform mathematical calculations on the data, combining data submitted by one user with data submitted by another and allocating data for activity that offers benefits to separate internal organizations. Users at higher level areas of responsibility may perform calculations independently of the software system using assumptions about cause and effect between interconnected accounts included in their organization's unique list of accounts to calculate data input into the system for predicting outcomes that can be compared to accounting system results that summarize business activity using the same cause and effect calculations for interconnected accounts.

To collect this data, the software systems typically present users with complex general ledger like screens within which they are to submit their data. However, these mechanisms are difficult to manipulate and use and, therefore, are not easily used by the wide variety of users that may be present in a given organization. In general, these mechanisms present a long list of general ledger accounts that correspond to accounts from the enterprise's accounting system chart of accounts that the users must choose between when submitting data. Because of these options, the users may submit incorrect data. Further, these mechanisms may make delegation of specific portions of data submission cumbersome, as the users must interact with some or all of the entire list of general ledger accounts to submit data. Moreover, these mechanisms typically require tedious reentry of interrelated data within the general ledger like screens should data assumptions used to create budgets and forecasts change.

Using the results of these calculations, the software systems may produce budget and forecast reports for review by higher management. These reports include predictions about future outcomes for business activities engaged in by the organization. Reports from the Organization's accounting system may include budget results for comparing predicted outcomes to accounting system outcomes. Higher level department of finance managers may direct the investigation and reporting of the sources and causes for differences between budget and accounting system outcomes may be investigated to determine the causes for the difference. The investigation and reporting process is complex and requires detailed analysis of input and processing of data in both the system for creating the budget and the accounting system.

Information about the Accounting Purpose of the Accounts is limited and not useful for analyzing either the relevancy of one account to another or the effect that activity in one account has upon other interconnected accounts.

Without intelligence about the Accounting Purposes of each account, these systems typically display a list of accounts in the same order as they appear in the Chart of Accounts from the Accounting System. Operators are tasked with repeatedly searching through the list of accounts to find the account they want to update. This results in complexity, a potentially greater risk of error and the possibility of omission of relevant data.

Further, an enterprise operation may control a plurality of subsidiary companies, each using separate accounting systems, with separate and different general ledger chart of accounts structures. Because of the different general ledgers, the enterprise operation will typically only roll-up financial information at a high-level, because the different chart of account structures makes detailed account aggregation and consolidation effectively impossible to perform on a recurring basis.

Therefore, such enterprise operations are often unable to perform enterprise level inventory management, and consequently are unable to centralize procurement, whereby inventory costs are increased due to the need for local ordering of inventory in smaller quantities.

As such, considering the foregoing, it may be appreciated that there continues to be a need for novel and improved devices and methods for enterprise manufacturing inventory management.

### SUMMARY OF THE INVENTION

The foregoing needs are met, to a great extent, by the present invention, wherein in aspects of this invention, enhancements are provided to the existing model of enterprise performance management.

In an aspect, a system for enterprise performance management, can include:
a) an enterprise performance management server;
b) an enterprise performance management device; and
c) a plurality of enterprise resource planning systems, each comprising a general ledger;
wherein the enterprise performance management server is configured to aggregate general ledger accounts from the general ledgers, such that the enterprise performance management server creates, stores, and processes an aggregated chart of accounts, comprising activity accounts, each comprising an activity id and associated planned cost and actual cost, which aggregates the general ledger accounts, such that the planned cost and the actual cost are aggregated according to a periodic schedule.

In a related aspect, the enterprise performance management server can further include:
a) a processor;
b) a non-transitory memory;
c) an input/output component;
d) an activity id correlation table, which is configured to correlate an activity account with at least one general ledger account from the at least one accounting system;
e) a planning account overview table, which specifies the aggregated chart of accounts; and
f) an account aggregation manager, which is configured to update the planning account overview table with aggregated information from the at least one general ledger, such that for each activity account the account aggregation manager aggregates actual cost and planned cost from correlated general ledger accounts via lookup in the activity id correlation table; all connected via
g) a data bus.

In a further related aspect, the activity id correlation table can include a plurality of correlation records, each correlation record comprising:
a) an activity id, including:
   an activity id number; and
   an activity id description;
a) a business id, which indicates that the business id is associated with a business operating with the at least one enterprise resource planning system and the at least one general ledger; and
b) a general ledger account, which is an account in the at least one general ledger of the at least one enterprise resource planning system, such that the activity id is associated with the general ledger account.

In a yet further related aspect, each correlation record of the plurality of correlation records can further include:
an account calculation procedure, which is configured to automate calculations of activity account adjustments that are a result of interconnected account relationships that are configured in the activity id connectivity table in relation to the activity id number.

In another related aspect, the planning account overview table can include a plurality of activity accounts, each activity account including:
a) an activity id, including:
   an activity id number; and
   an activity id description;
b) a planned cost, which denotes an aggregated planned cost for the activity account; and
c) an actual cost, which denotes an aggregated actual cost for the activity account.

In yet another related aspect, the enterprise performance management server can further include:
a) an activity id connectivity table, which for each specific activity account correlates the specific activity account with an associated contra activity account and an associated cross charge account; and
b) an account planning manager, which processes the account calculation procedure, such that the account planning manager processes updates of the planned cost of the specific activity account to automatically update planned cost of interconnected activity accounts that are configured in the activity id connectivity table in relation to the activity id number.

In a further related aspect, the activity id connectivity table can include a plurality of connectivity records, each connectivity record including:
a) a first activity id, including:
   an activity id number;
   an activity id description;
a) a one-to-one flag, which is configured to indicate if the activity id has a one-to-one relationship with a corresponding general ledger account of the at least one enterprise resource planning system;
b) a contra activity id, which indicates a second activity id for contra posting in relation to the activity id; and
c) a cross charges activity id, which indicates a third activity id for cross charging in relation to the activity id.

In another aspect, a method for enterprise performance management, can include:
a) Creating an aggregated chart of accounts, including creating a planning account overview table of activity accounts, each including an activity id and associated planned cost and actual cost, by aggregating general ledger accounts from at least one general ledger;
   wherein the planning account overview table is created by an enterprise performance management server;
b) Updating planning information, comprising processing updates of planned cost of an activity account in the planning account overview table, to automatically update planned cost of interconnected activity accounts, which are configured in an activity id connectivity table in relation to an activity id of the activity account;
c) ordering manufacturing inventory, wherein a manufacturing activity account in the activity accounts, comprises a manufacturing planning activity id for a manufacturing input component used in manufacturing by a first factory and a second factory, associated with respectively a first accounting system and a second accounting system;
   wherein the manufacturing activity account comprises a manufacturing aggregated forecasted quantity for the manufacturing input component;
   such that the manufacturing aggregated forecasted quantity of the manufacturing input component is ordered via an inventory procurement system; and
d) distributing the manufacturing aggregated forecasted quantity of the manufacturing input component to the first factory and the second factory.

In yet another related aspect, a system for enterprise manufacturing inventory management can include the system for enterprise performance management, wherein a manufacturing activity account in a plurality of activity accounts, can include a manufacturing planning activity id for a manufacturing input component used in manufacturing by a first factory and a second factory, associated with respectively a first accounting system and a second accounting system;

wherein the manufacturing activity account can include a manufacturing aggregated forecasted quantity for the manufacturing input component;
such that the enterprise performance management server can be configured to order the manufacturing aggregated forecasted quantity of the manufacturing input component via an inventory procurement system, such that the manufacturing aggregated forecasted quantity of the manufacturing input component can be distributed to the first factory and the second factory.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. In addition, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1A is a schematic diagram illustrating a system for enterprise manufacturing inventory management, according to an embodiment of the invention.

FIG. 1B is a schematic diagram illustrating a system for enterprise performance management, according to an embodiment of the invention.

FIG. 2 is a schematic diagram illustrating an enterprise performance management server, according to an embodiment of the invention.

FIG. 3 is a schematic diagram illustrating an enterprise performance management device, according to an embodiment of the invention.

FIG. 4A is a schematic diagram illustrating an activity id correlation table of a system for enterprise performance management, according to an embodiment of the invention.

FIG. 4B is a schematic diagram illustrating an activity id connectivity table of a system for enterprise performance management, according to an embodiment of the invention.

FIG. 4C is a schematic diagram illustrating a planning account overview table of a system for enterprise performance management, according to an embodiment of the invention.

FIG. 4D is a schematic diagram illustrating a general ledger account overview table of a system for enterprise performance management, according to an embodiment of the invention.

FIG. 4E is a schematic diagram illustrating an activity id hierarchy of a system for enterprise performance management, according to an embodiment of the invention.

FIG. 5A is a flowchart illustrating steps that may be followed, in accordance with one embodiment of an account calculation procedure of a system for enterprise performance management.

FIG. 5B is a flowchart illustrating steps that may be followed, in accordance with one embodiment of an account calculation procedure of a system for enterprise performance management.

FIG. 5C is a flowchart illustrating steps that may be followed, in accordance with one embodiment of an account calculation procedure of a system for enterprise performance management.

FIG. 5D is a flowchart illustrating steps that may be followed, in accordance with one embodiment of an account calculation procedure of a system for enterprise performance management.

FIG. 5E is a flowchart illustrating steps that may be followed, in accordance with one embodiment of an account calculation procedure of a system for enterprise performance management.

FIG. 5F is a flowchart illustrating steps that may be followed, in accordance with one embodiment of an account calculation procedure of a system for enterprise performance management.

FIG. 5G is a flowchart illustrating steps that may be followed, in accordance with one embodiment of an account calculation procedure of a system for enterprise performance management.

FIG. 5H is a flowchart illustrating steps that may be followed, in accordance with one embodiment of an account calculation procedure of a system for enterprise performance management.

FIG. 5I is a flowchart illustrating steps that may be followed, in accordance with one embodiment of a method or process of enterprise performance management.

FIG. 5J is a flowchart illustrating steps that may be followed, in accordance with one embodiment of an account calculation procedure of a system for enterprise performance management.

FIG. 5K is a flowchart illustrating steps that may be followed, in accordance with one embodiment of an account calculation procedure of a system for enterprise performance management.

FIG. 6A is an illustration of a graphical user interface of a system for enterprise performance management, according to an embodiment of the invention.

FIG. 6B is an illustration of a graphical user interface of a system for enterprise performance management, according to an embodiment of the invention.

FIG. 6C is an illustration of a graphical user interface of a system for enterprise performance management, according to an embodiment of the invention.

FIG. 6D is an illustration of a graphical user interface of a system for enterprise performance management, according to an embodiment of the invention.

FIG. 7 is a flowchart illustrating steps that may be followed, in accordance with one embodiment of a method or process of enterprise manufacturing inventory management.

### DETAILED DESCRIPTION

Before describing the invention in detail, it should be observed that the present invention resides primarily in a novel and non-obvious combination of elements and process steps. So as not to obscure the disclosure with details that will readily be apparent to those skilled in the art, certain conventional elements and steps have been presented with lesser detail, while the drawings and specification describe in greater detail other elements and steps pertinent to understanding the invention.

The following embodiments are not intended to define limits as to the structure or method of the invention, but only to provide exemplary constructions. The embodiments are permissive rather than mandatory and illustrative rather than exhaustive.

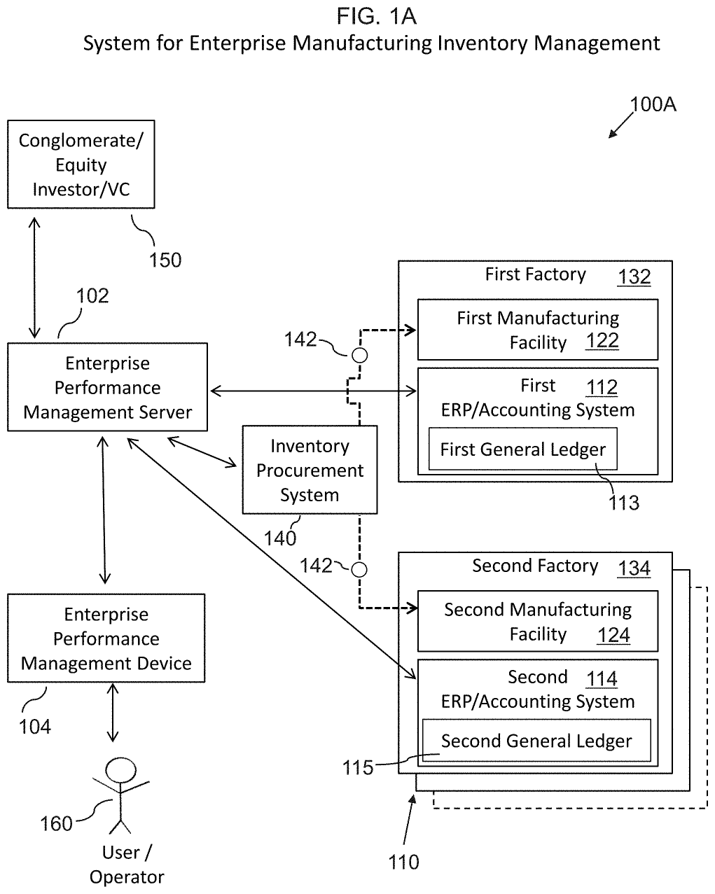

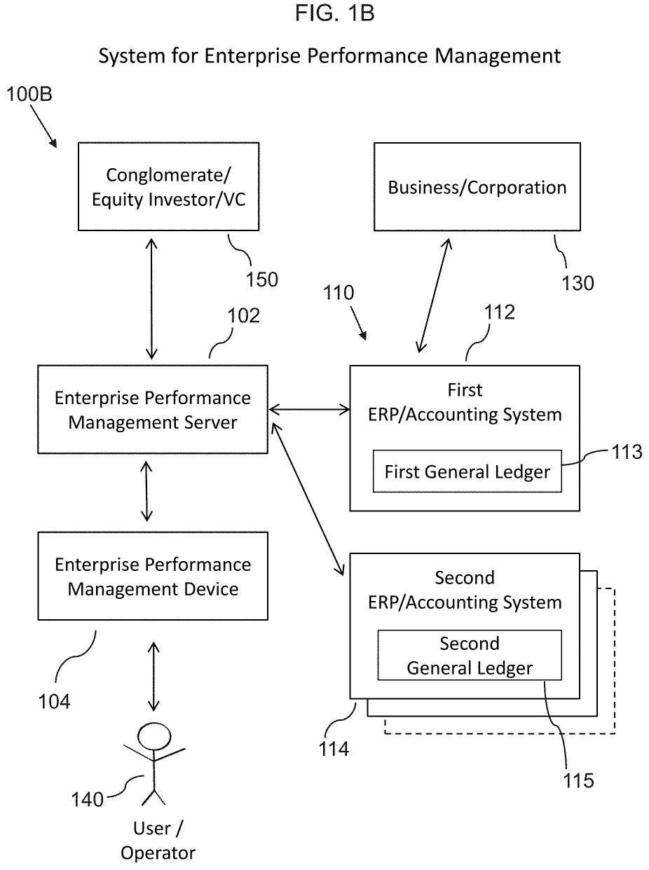

In the following, we describe the structure of an embodiment of a system for enterprise performance management 100 with reference to FIGS. 1A and 1B, in such manner that like reference numerals refer to like components throughout; a convention that we shall employ for the remainder of this specification.

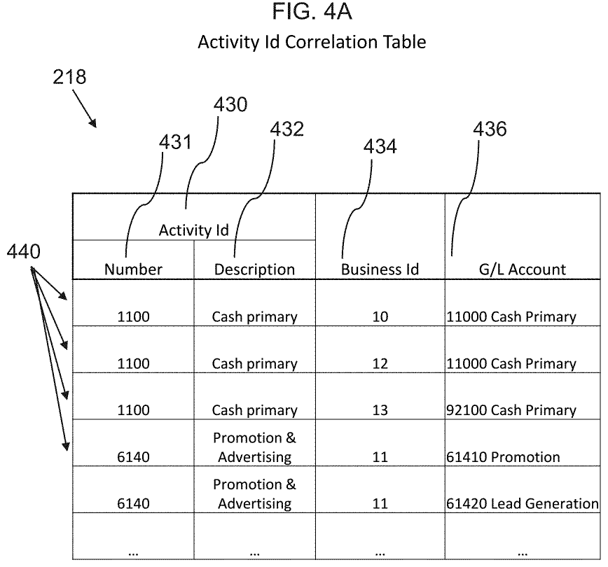

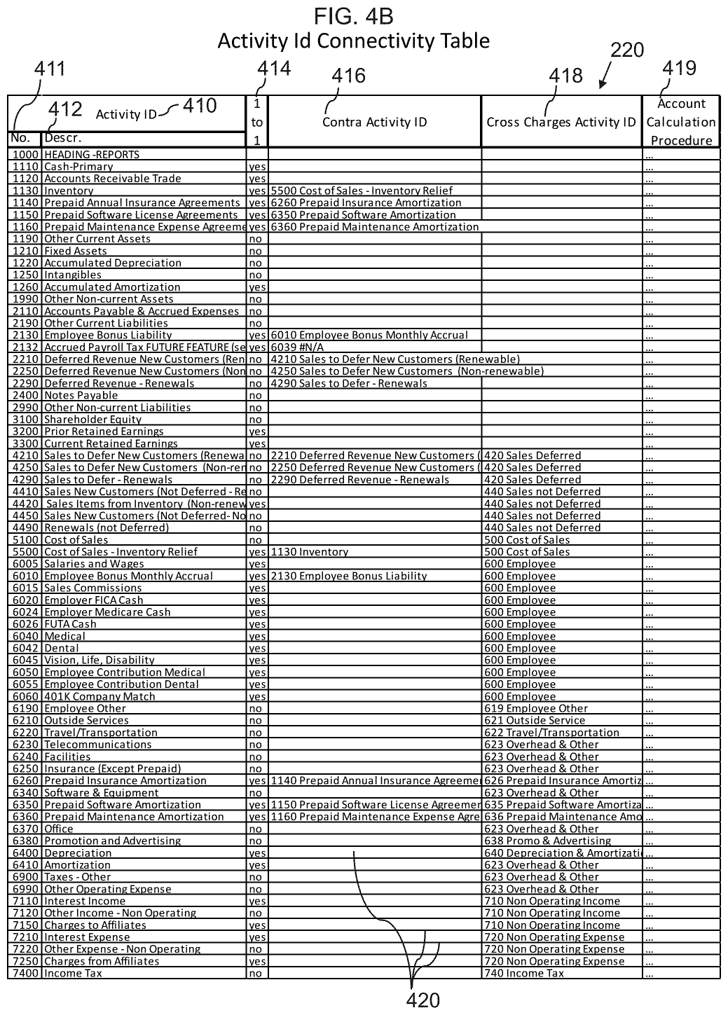

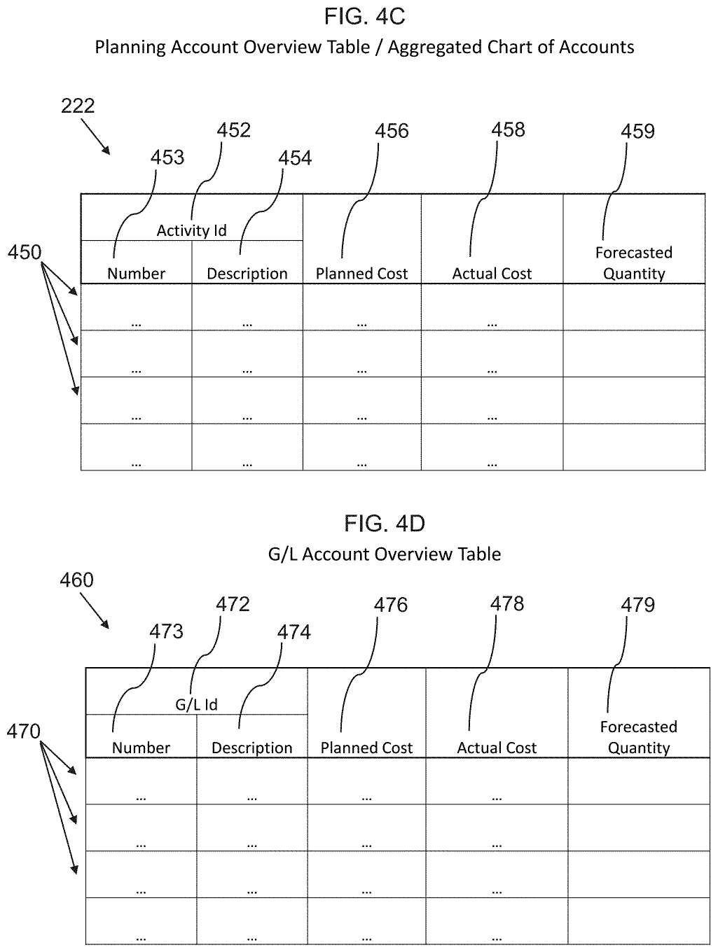

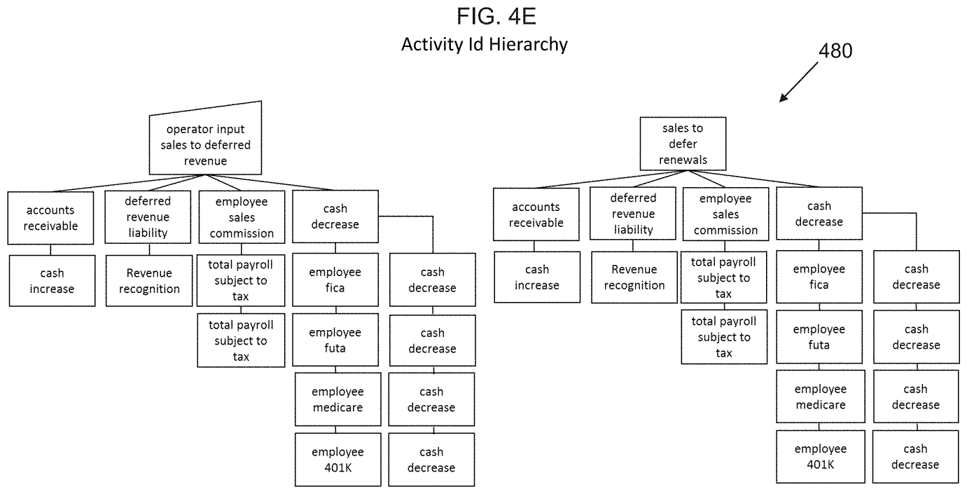

In an embodiment, as shown in FIG. 1B, a system for enterprise performance management 100B can include:
a) An enterprise performance management server 102;
b) An enterprise performance management device 104; and
c) At least one enterprise resource planning system 110, comprising at least one general ledger 113, wherein the at least one enterprise resource planning system can be a plurality of enterprise resource planning/accounting systems 110, which can include:
   i. A first enterprise resource planning/accounting system 112, including a first general ledger 113; and
   ii. A second enterprise resource planning system/accounting 114, including a second general ledger 115;

wherein the enterprise performance management server 102 is configured to aggregate general ledger accounts 470 from the at least one general ledger 113, such that the enterprise performance management server 102 creates, stores, and processes a planning account overview table 222, as shown in FIG. 4C, comprising a plurality of activity accounts 450, which can also be referred to as planning records 450, each comprising an activity id 452 and associated planned cost 456 and actual cost 458, which aggregate the general ledger accounts 436 from the at least one general ledger 113, as shown in FIG. 4A. Planned and actual cost 456 458 can be aggregated according to a periodic schedule, which typically can be specified by month, quarter, and/or year, but can be done by any predetermined periodic schedule.

In a related embodiment, an enterprise performance management server 102 can include:
a) A processor 202;
b) A non-transitory memory 204;
c) An input/output component 206;
d) An activity id correlation table 218, which is configured to correlate an activity account 450 with at least one general ledger 113 account from the at least one accounting system 112;
e) An activity id connectivity table 220, which for each specific activity account 450 is configured to correlate the specific activity account 450 with an associated contra activity account 416 and an associated cross charge account 418;
f) A planning account overview table 222, which comprises the aggregated chart of accounts;
g) An account aggregation manager 210, comprising account aggregation manager instructions 210, which are configured to update the planning account overview table 222 with aggregated information from the at least one general ledger 113, such that for each activity account 450 the account aggregation manager 210 aggregates actual cost 458 and planned cost 456 from correlated general ledger accounts 436 via lookup in the activity id correlation table 218;
h) An account planning manager 212, comprising account planning manager instructions 212, which are configured to process the account calculation procedure 419, shown in FIG. 4B, such that the account planning manager 212 processes updates of planned cost 456 of the specific activity account 450 to automatically update planned cost 456 of interconnected activity accounts 450 that are configured in the activity id connectivity table 220 in relation to the activity id number; all connected via
i) A data bus 230.

In a related embodiment, an enterprise performance management device 104 can include:
a) A processor 302;
b) A non-transitory memory 304;
c) An input/output 306;
d) An account aggregation controller instructions 310, which are configured to allow a user 160 to view the planning account overview table in communication with the account aggregation manager 210;
e) An account planning controller instructions 312, which is configured to allow a user 160 to view and update the aggregated planned cost of the planning account overview table in communication with the account planning manager 212; all connected via
f) A data bus 320.

In a related embodiment, as shown in FIG. 4A, the enterprise performance management server 102 can be configured to store an activity id correlation table 218, comprising a plurality of correlation records 440, each correlation record 440 including the following fields:
a) A correlation activity id 430, including:
   i. A correlation activity id number 431; and
   ii. A correlation activity id description 432;
b) A business id 434, which indicates that the business id 434 is associated with a business/factory 130, 132, 134, which is operating with an accounting system based 112, that includes a general ledger 113; and
c) A general ledger account 436, which is (i.e. references) an account in the general ledger 113 of the accounting system 112, such that the activity id 430 is associated with the general ledger account 436.

The activity id 430 can alternatively be referred to as an activity type 430, such that the corresponding fields are referred to as an activity type number 431 and an activity type description 432. In another alternative naming convention, the activity id 430 can be referred to as an activity identifier 430, such that the corresponding fields are referred to as an activity identifier number 431 and an activity identifier description 432.

In related embodiments, the activity id number 431 can be a number, but can alternatively be configured as another type of code, such as a character string.

In a related embodiment, the activity id correlation table 218 correlates a business activity type to each general ledger chart of accounts value for every business in each industry.

In another related embodiment, the activity id correlation table 218 can be configured to organize general ledger accounts between high value and low value activities and categories that include all accounts that define a set of activities that share common business activity. For example, all Travel Accounts, all Promotion and Advertising, and all Overhead accounts can be identified by an activity id code that enables the system to present each group of accounts individually for presentation to specific operators that are identified by a User Role code.

In another related embodiment, activity id correlation table 218 can be configured to identify Accounts that contain useful data about activity that increases an account as distinguished from activity that decreases an account. For example, an Account with an Activity ID code for Annual Prepaid Insurance Asset increases as Annual Payments are made to the vendor and decreases as Payments are Amortized to Expense monthly over the Term of the Agreement. Interdependencies between the Prepaid Expense Asset account and other accounts include Cash (which decreases to offset increases in Prepaid Insurance as payments are made) and Insurance Expense (which increases to offset decreases in the Prepaid Account).

In a related embodiment, as shown in FIG. 4B, the enterprise performance management server 102 can be configured to store an activity id connectivity table 220, comprising a plurality of connectivity records 420, each connectivity record 420 including the following fields:
a) A connectivity activity id 410, including:
   i. a connectivity activity id number 411;
   ii. a connectivity activity id description 412;
b) A one-to-one flag 414, which indicates if the activity id 410 has a one-to-one relationship with a corresponding general ledger account 436 (shown in FIG. 4A) of a corresponding accounting system 110, which has a business Id 434 (shown in FIG. 4A);
c) A contra activity id 416, which indicates a second activity id 410 for contra posting in relation to the activity id 410;
d) A cross charges activity id 418, which indicates a third activity id 410 for cross charging in relation to the activity id, such as for example a shared service cross charge account; and
e) An account calculation procedure 419.

In a further related embodiment, FIG. 4B further shows an example of a populated activity id connectivity table 220 that is configured for use for the software industry businesses. When business activity ids from the table are mapped to each account for each organization in the software industry the system imprints the accounts with data that's used to calculate activity between interconnected accounts and to organize accounts in logical groups of accounts with shared attributes using intelligence about the nature of activity in each account. One to one business activity id codes are used to describe accounts that are used for a single specific purpose. For example, enterprises conventionally use a single account for recording cash transactions. Advertising and promotion activity is typically recorded in multiple accounts. Each business activity id describes separate economic activities that businesses perform in their respective industry.

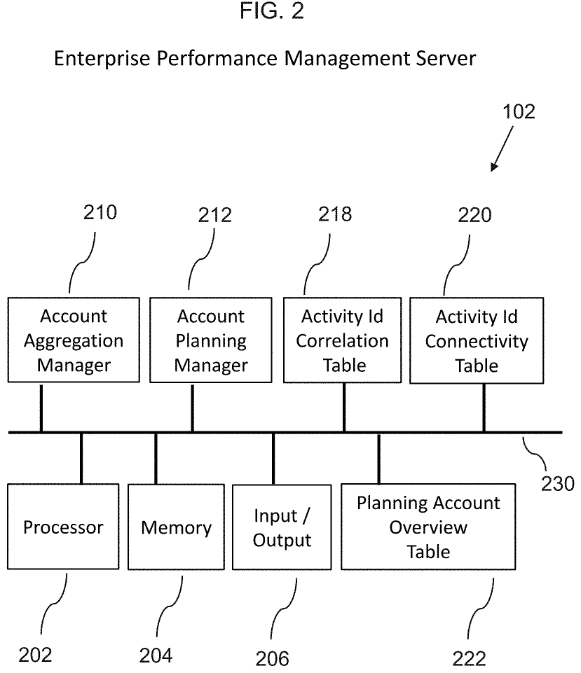

In a related embodiment, the activity id connectivity table 220 for each connectivity record 420 defines an associated account calculation procedure 419, which for example can be stored as database routine, such as a stored procedure, which account calculation procedure 419 automates calculations of activity account 410 adjustments that are a result of interconnected account relationships that are configured in the activity id connectivity table 220 (shown in FIGS. 2 and 4B) in relation to the activity id number, and to use for populating forms with data designed for analyzing activities with shared attributes. One to One business activity types map to a single general ledger account for incorporating business intelligence used to design calculations for determining the nature of activity in one or more accounts and the impact of activity upon one or more other accounts.

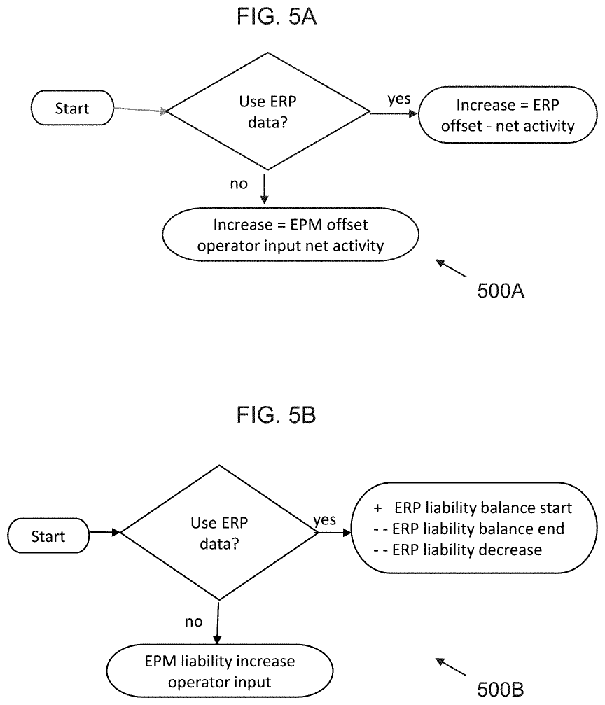

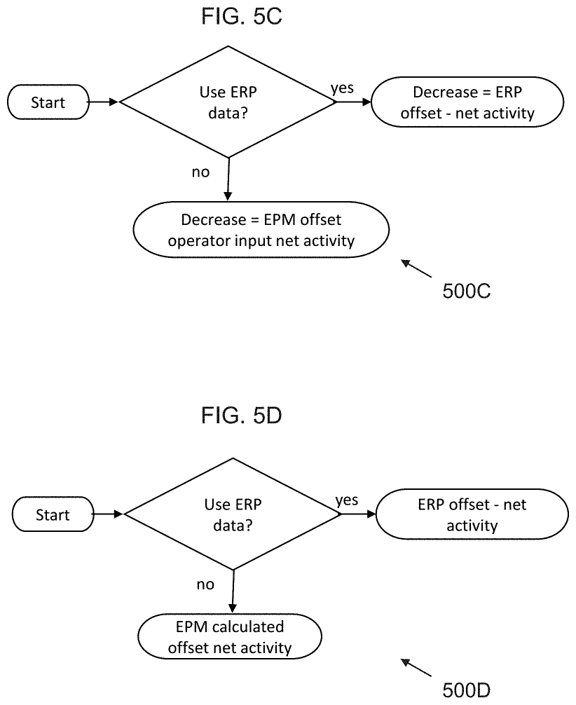

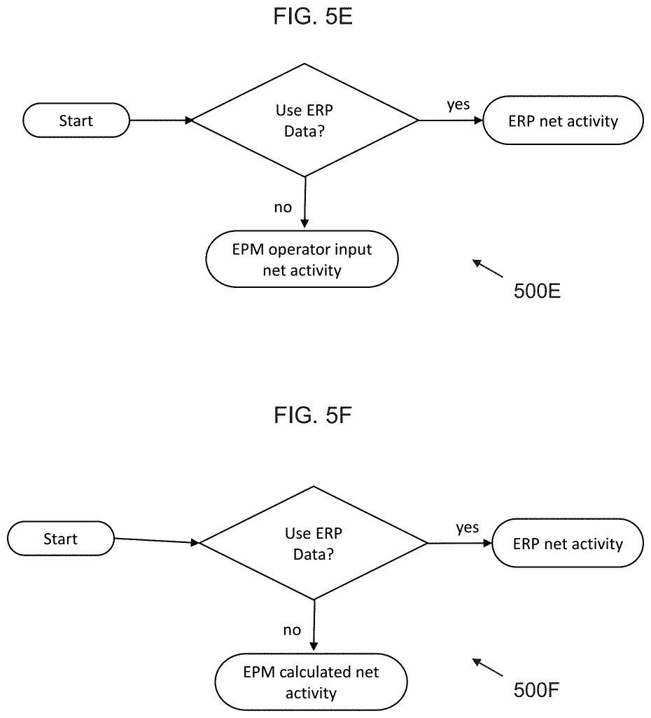

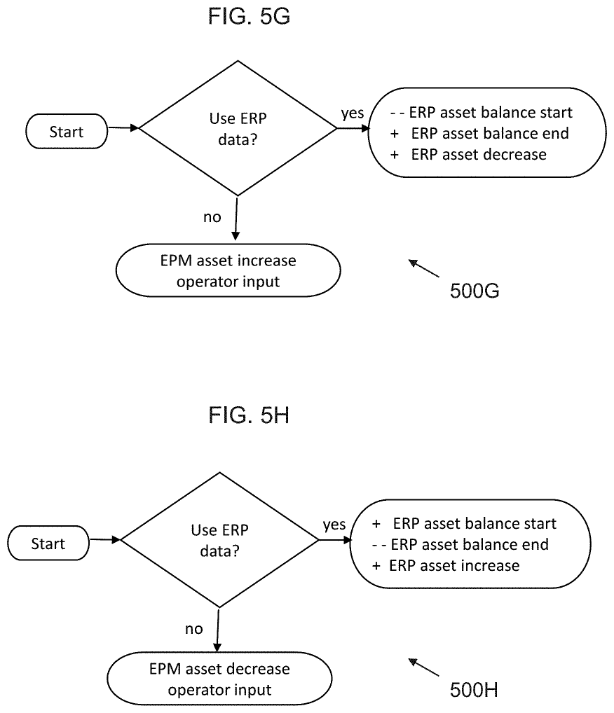

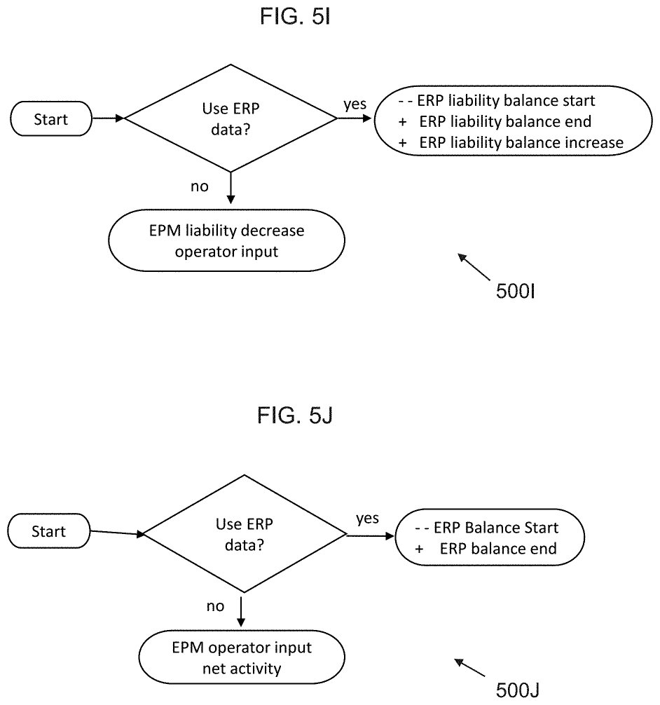

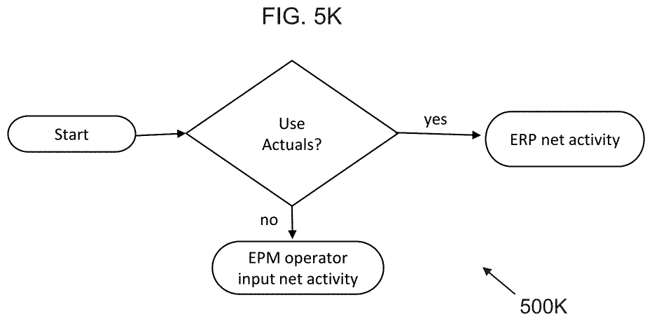

In a further related example embodiment, an account calculation procedure 419 for an inventory activity account 410 increase, can include an offset account 416 decrease, for an interconnected Cost of Sales Purchase for Resale contra activity account 416, such as shown in FIG. 5C, and explained in further detail below.

In a further related embodiment, the activity id connectivity table 220 can include a connectivity record 420, wherein the one-to-one flag 414 is set to true and corresponding correlation records 440 are configured to comprise at least one correlation activity id 430 configured for one-to-one use, such that there is at most one corresponding general ledger account 470 for each business id 434.

In another further related embodiment, the activity id connectivity table 220 can include a connectivity record 420 with a single contra account 416, wherein the one-to-one flag 414 is set to true, and corresponding correlation records 440 are configured to comprise at least one correlation activity id 430 configured for one-to-one use, such that there is at most one corresponding general ledger account 470 for each business id 434.

In yet another further related embodiment, the activity id connectivity table 220 can include connectivity records 420 with a plurality of contra accounts 416, wherein the one-to-one flag 414 is set to true, and corresponding correlation records 440 are configured to comprise at least one correlation activity id 430 configured for one-to-one use, such that there is at most one corresponding general ledger account 470 for each business id 434.

In a further related embodiment, the activity id connectivity table 220 can include a connectivity record 420, wherein the one-to-one flag 414 is set to false and corresponding correlation records 440 are configured to comprise at least one correlation activity id 430 configured for one-to-many use, such that there is more than one corresponding general ledger account 113 115 for at least one business id 434.

In a related embodiment, as shown in FIG. 4C, the enterprise performance management server 102 can be configured to store and process an aggregated chart of accounts 222, in the form of a planning account overview table 222 of activity accounts 450, each including the following fields:
a) A planning activity id 452, including:
   i. A planning activity id Number 453;
   ii. A planning activity id Description 454;
b) A planned cost 456, which denotes aggregated planned cost for the activity account 450;
c) An actual cost 458, which denotes aggregated actual cost for the activity account 450; and
d) A forecasted quantity 459, which denotes aggregated forecasted quantity for the activity account 450;
wherein the planned cost, the actual cost, and the forecasted quantity 459 can be further specified according to a periodic schedule.

In a related embodiment, as shown in FIG. 4D, the general ledger 113 115 can be configured to store and process a general ledger chart of accounts 460, for example in the form of a general ledge account overview table 460 of general ledger accounts 470, each including the following fields:
a) A general ledger id 472, including:
   i. A general ledger id Number 473;
   ii. A general ledger id Description 474;
b) A general ledger planned cost 476;
c) A general ledger actual cost 478; and
d) A general ledger forecasted quantity 479;
wherein the planned and actual cost 476 478 can be further specified according to a periodic schedule. The general ledger chart of accounts 460 may include additional entities, attributes, etc., to describe various embodiments of a general ledger 113 115.

In another related embodiment, FIG. 4E shows an activity id hierarchy 480, which is an example of interconnected account activity calculations initiated by operator data input into a sales account. The system for enterprise performance management 100 uses embedded information about accounts that is derived from the business activity id that is assigned to each account. The system for enterprise performance management 100 uses intelligence about the accounting use of accounts to calculate activity in interconnected asset, liability, revenue and expense accounts. Using account intelligence to separately analyze activity within a single asset or liability account provides data used in system calculations that ordinarily take place outside of budget, forecast and reporting software systems including calculations for arriving at net activity within in an account. Several accounts include both cash and non-cash components, some do not have a cash component.

Thus, FIG. 4E shows that account activity in one or multiple accounts has a direct impact on one or multiple other accounts. Business activity ids are mapped to general ledger accounts for integrating intelligence about the accounting purpose of an account useful for automating processes. FIG. 4E is an example of the calculated effect that is a result of an operator sales input on multiple accounts over multiple periods.

In an example embodiment, FIG. 5A illustrates a flowchart 500A for an account calculation procedure 419 for asset accounts with activity ids that increase by an amount equal to an increase in a non-cash offset accounts. For example, Accounts Receivable increases by an amount equal to Sales to Customers. The same Accounts Receivable decreases by an amount equal to collections, which is defined as collection of Sales to Customers which is offset to Cash as described at FIG. 5H. FIG. 5A also includes liability accounts that increase by an amount equal to an increase in a non-cash offset account. For example, periodic accruals for payments due in future periods. The same accrual account is decreased by operator input payments of liabilities when due. For example, a liability for Employee Bonus payments increases with operator input for monthly provisions, decreases in the liability account and also impacts cash as described in FIG. 5I.

Thus, FIG. 5A illustrates a one to one asset or liability account increase equal to operator net activity input. For example, accounts receivable asset increases by an amount equal to operator sales input, employee bonus liability increases by an amount equal to operator bonus accrual input. Version control end date for accounting system data (ERP) determines data source.

In an example embodiment, FIG. 5B illustrates a flowchart 500B for an account calculation procedure 419 for a liability account increase equal to operator net activity input. For example, deferred revenue increases by an amount equal to operator sales to deferred revenue input. Version control end date for accounting system data (ERP) determines data source.

In an example embodiment, FIG. 5C illustrates a flowchart 500C for an account calculation procedure 419 for a one to one asset or liability account decrease equal to operator input to an offset account. For example, inventory of items held for resale asset decreases equal to items held for resale cost of sales operator input. Version control end date for accounting system data (ERP) determines data source.

In an example embodiment, FIG. 5D illustrates a flowchart 500D for an account calculation procedure 419 for an asset or liability decrease equal to calculated net activity in an offset account. For example, prepaid expense asset decreases equal to calculated amortization of prepayments, deferred revenue liability decreases equal to calculated revenue recognition of operator sales input. Version control end date for accounting system data (ERP) determines data source.

In an example embodiment, FIG. 5E illustrates a flowchart 500E for an account calculation procedure 419 for operator input to a one to one expense account equal to an offset to an asset or liability account. For example, operator input of cost of items purchased for resale equal to inventory of items purchased for resale asset decreases. Version control end date for accounting system data (ERP) determines data source.

In an example embodiment, FIG. 5F illustrates a flowchart 500F for an account calculation procedure 419 for a revenue or expense account with an increase equal to an offset in an asset or liability account. For example, calculated amortization of prepayments equal to prepaid expense asset decreases, calculated revenue recognition equal to deferred revenue liability decreases. The version control end date for accounting system 110 data (ERP) determines data source.

In an example embodiment, FIG. 5G illustrates a flowchart 500G for an account calculation procedure 419 for a one to one asset account increase equal to operator asset account increase input. For example, inventory of items held for resale increases equal to items in inventory purchased for resale operator input. Version control end date for accounting system data (ERP) determines data source.

In an example embodiment, FIG. 5H illustrates a flowchart 500H for an account calculation procedure 419 for a one to one asset account decrease equal to operator asset account decrease input. For example, accounts receivable decreases equal to sales collections. Version control end date for accounting system data (ERP) determines data source.

In an example embodiment, FIG. 5I illustrates a flowchart 500I for an account calculation procedure 419 for a one to one liability account decrease equal to operator liability account decrease input. For example, employee bonus liability decreases by an amount equal to operator bonus payment input. Version control end date for accounting system data (ERP) determines data source.

In an example embodiment, FIG. 5J illustrates a flowchart 500J for an account calculation procedure 419 for a one to many asset or liability account net activity equal to operator net activity input. For example, fixed assets asset net increase/decrease by an amount equal to operator input, notes payable net increase/decrease by an amount equal to operator input. Version control end date for accounting system data (ERP) determines data source.

In an example embodiment, FIG. 5K illustrates a flowchart 500K for an account calculation procedure 419 for a one to many income statement account net activity equal to operator net activity input. For example, office rent net activity amount equal to operator input, interest income net activity amount equal to operator input. Version control end date for accounting system data (ERP) determines data source.

In related embodiments, the use of activity ids for defining the nature of account increases and decreases independently of each other is also used to automate the separate contributors to increases and decreases included with net activity reported in the accounting system (ERP). For example, FIGS. 5I and 5J show calculations for asset and liability decreases that are only possible because of the account offset data included with the activity account codes for the assets and liabilities.

Account intelligence is also used to define separate sources of increases and decreases in account that may or may not impact cash. For example, FIG. 5B describes a Liability increase equal to a non-cash account which is offset by a non-cash example provided by FIG. 5D. An increase in the liability account Deferred Revenue equal to operator sales to defer non-cash input is offset by decreases in the same liability account by non-cash revenue that is recognized on the P&L. The Asset decrease for a Prepaid Annual Expense described at FIG. 5D is non-cash amortization that is offset by an increase in the same asset account by an amount equal to operator input for annual cash payments described at FIG. 5G. FIG. 5G also describes an increase in the Asset account for Items purchased for resale held in inventory which reduces cash by an amount equal to purchases and imbedded account type intelligence is used to calculate decreases in the same asset account that are a result of non-cash expensing of cost of inventory items sold as defined by FIG. 5C.

In related embodiments, Business activity ids are used to identify all accounts as either being cash or non-cash. The distinction is useful for analyzing activity in accounts to determine their contribution to the sources and uses of cash. Cash calculations include increases or decreases as a result of operator input described at FIGS. 5J and 5K. FIGS. 5G, 5H and 5I are activities that also impact cash. FIGS. 5A, 5B, 5C and 5D describe activity that does not impact cash and FIG. 5E describes non-cash system calculations.

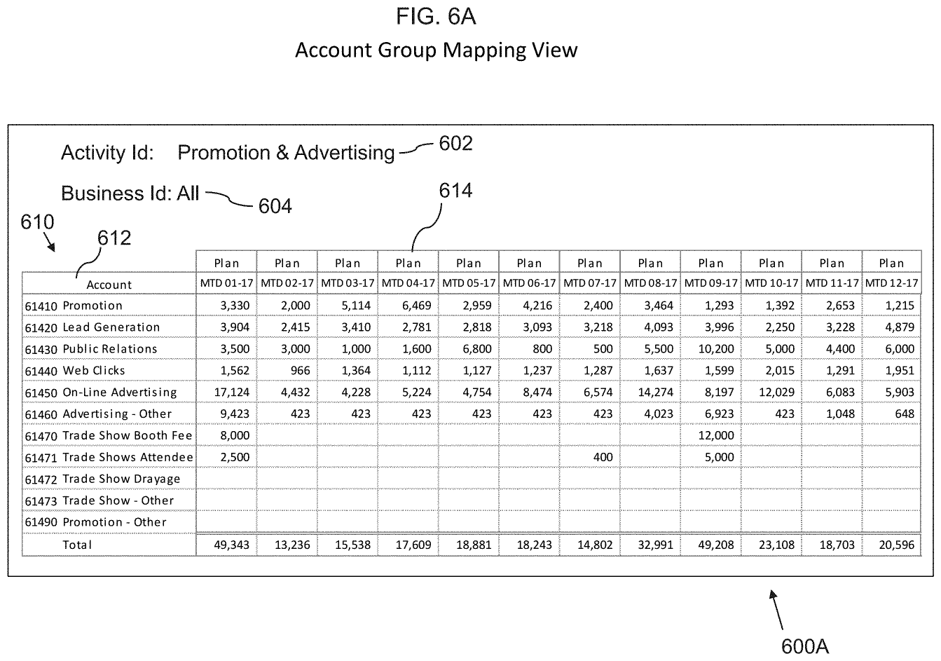

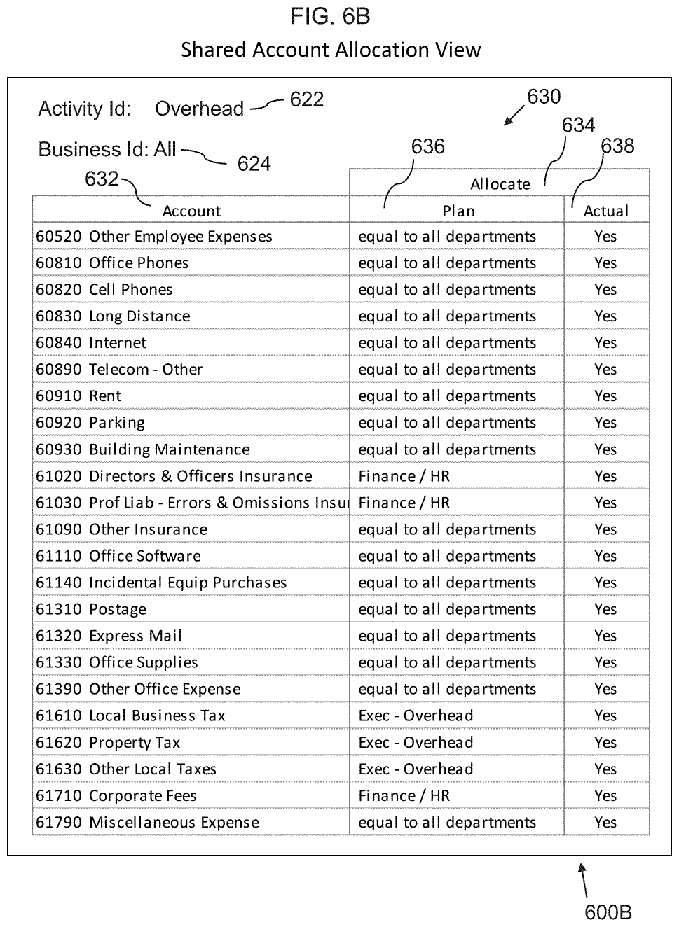

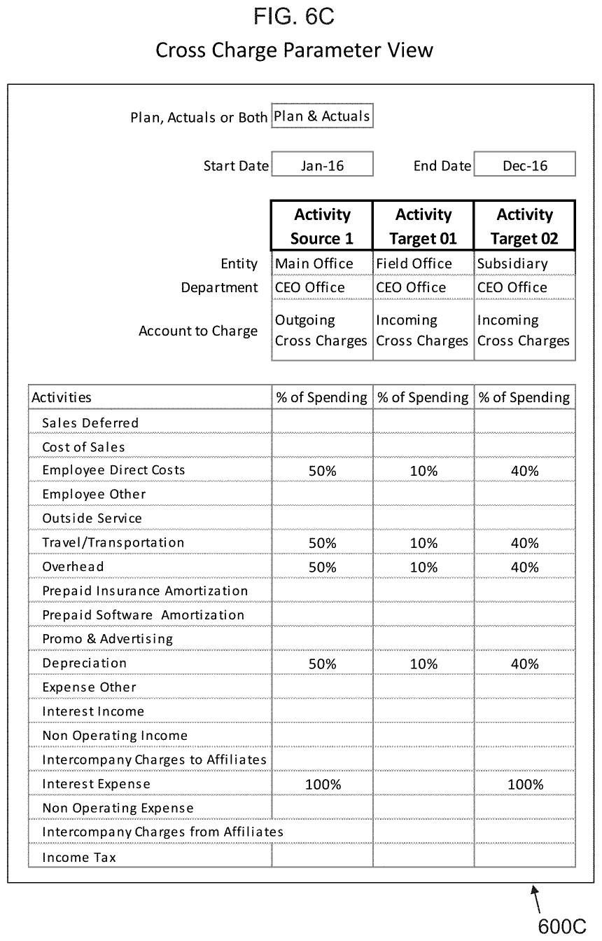

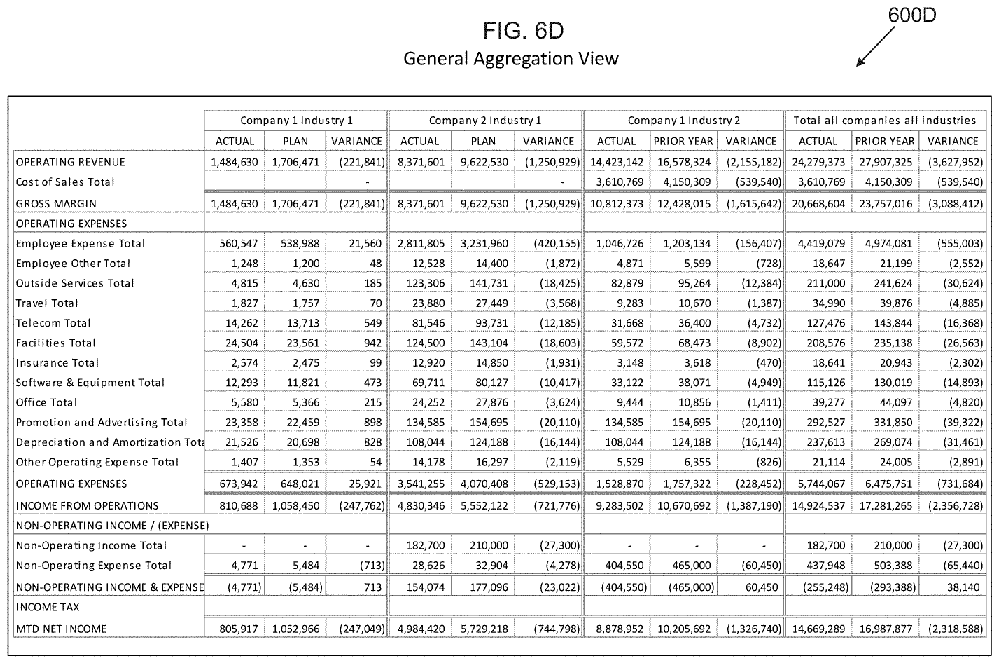

In a related embodiment, as shown in FIG. 6A, the account aggregation controller 310, in communication with the account aggregation manager 210, can be configured to provide a user 160 with an account group mapping view 600A, which includes:
a) An activity id selector field 602;
b) A business id selector field 604; and
c) A general ledger account list of records 610, each record 610 including:
   i. An account id 612, which is a general ledger account of the general ledger 113; and
   ii. A planned Cost by Month 614;
wherein the account group mapping view 600A can be configured to enable a user 160 to view and update groups of accounts identified by business activity ids with shared attributes independently of other accounts from the general ledger list of accounts, in order to eliminate or reduce the difficulty of choosing between accounts presented in a long list of general ledger accounts that are conventionally displayed for operators to choose between when submitting data. FIG. 6A shows an example of a group of accounts which display specific accounts that map to a specific business activity id for ‘promotion and advertising’, which are distinguished from other activities that businesses in the software industry typically engage in.

In a related embodiment, as shown in FIG. 6B, the account aggregation controller 310, in communication with the account aggregation manager 210, can be configured to provide a user 160 with a shared account allocation view 600B, which includes:
a) An activity id selector field 622;
b) A business id selector field 624; and
c) A general ledger account list of records 630, each record 630 including:
   iii. General ledger number and description 632; and
   iv. Allocation overview 634, including:
      Planned allocation 636; and
      Actual Allocation Flag 638, which indicates whether planned allocation is applied to actuals;
wherein the shared account allocation view 600B can be configured to enable a user 160 to view and update groups of accounts identified by business activity ids with shared attributes independently of other accounts from the general ledger list of accounts including operator options for allocating activity for each account to and between internal organizations (departments) for both EPM and Accounting System account activity for the purpose of developing activity for departments in both the EPM and Accounting systems that have been calculated from using identical methodology.

In a related embodiment, as shown in FIG. 6C, the account aggregation controller 310, in communication with the account aggregation manager 210, can be configured to provide a user 160 with a cross charge parameter view 600C, which shows the use of business activity codes to present and display summary groups of accounts with shared attributes in a form that operators populate with data for distributing activity from one internal organization to one or more separate internal or external organizations. Organizational activity originating in one organization that produces a benefit to one or more separate organizations (departments, locations and affiliates) the system for enterprise performance management 100 provides for identification of account activities using business activity codes, and allocation calculations for either or both EPM, Accounting System results between organizations to more accurately reflect the total activity engaged in by each organization.

In a related embodiment, as shown in FIG. 6D, the account aggregation controller 310, in communication with the account aggregation manager 210, can be configured to provide a user 160 with a general aggregation view 600D, which shows activity codes for separate industry users each using an enterprise resource planning systems 112. When multiple companies in multiple industries, as shown in FIG. 1B, are part of a combined group 150, or conglomerate 150, of businesses/factories 130, 132, 134, as is the case with companies 150 and their subsidiaries/affiliate businesses/factories 130, 132, 134 or investment organizations 150, such as venture capital 150, private equity 150 etc., both the planning and actual results can be compared side by side and in total as aggregated results.

In related embodiments, the enterprise performance management device 104 can include configurations as:
a) A web application, executing in a Web browser;
b) A tablet app, executing on a tablet device, such as for example an Android or iOS tablet device;
c) A mobile app, executing on a mobile device, such as for example an Android phone or iPhone, or any wearable mobile device;
d) A desktop application, executing on a personal computer, or similar device; and
e) An embedded application, executing on a processing device, such as for example a smart TV, a game console or other system.

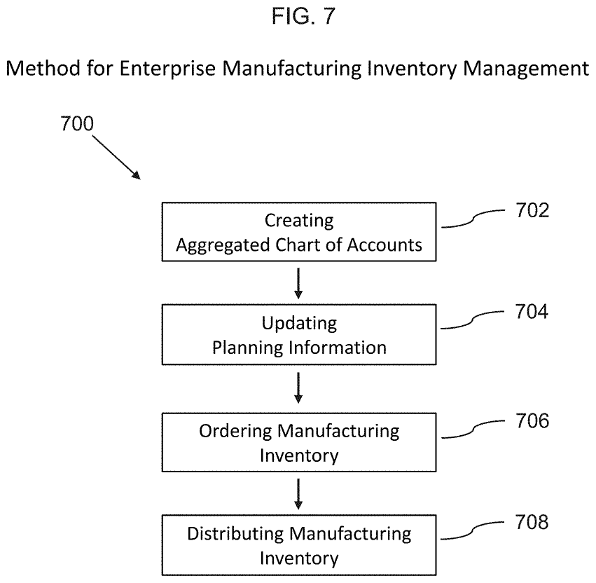

In an embodiment, as illustrated in FIG. 7, a method for enterprise performance management 700, can include:
a) Creating an aggregated chart of accounts 702, comprising creating a planning account overview table 222 of activity accounts 450, each comprising an activity id 452 and associated planned cost 456 and actual cost 458, by aggregating general ledger accounts 436 from at least one general ledger 113;
   wherein the planning account overview table 222 is created by an enterprise performance management server 102;
b) Updating planning information 704, comprising processing updates of planned cost 456 of an activity account 450 in the planning account overview table 222, to automatically update planned cost 456 of interconnected activity accounts 450, which are configured in an activity id connectivity table 220 in relation to an activity id 452 of the activity account 450;
c) ordering manufacturing inventory 706, wherein a manufacturing activity account 450 in the activity accounts 450, comprises a manufacturing planning activity id 452 for a manufacturing input component 142 used in manufacturing by a first factory 132 and a second factory 134, associated with respectively the first accounting system 112 and the second accounting system 114;
   wherein the manufacturing activity account 450 comprises a manufacturing aggregated forecasted quantity 459 for the manufacturing input component 142;
   such that the manufacturing aggregated forecasted quantity 459 of the manufacturing input component 142 is ordered via an inventory procurement system 140; and
d) distributing the manufacturing inventory 708, wherein the manufacturing aggregated forecasted quantity 459 of the manufacturing input component 142 is distributed to the first factory 132 and the second factory 134.

In a related embodiment, the method for enterprise performance management 700, can further include:
updating the planning account overview table 222 with aggregated information from the at least one general ledger 113, by aggregating, for each activity account 450, the actual cost 458 and planned cost 456 from correlated general ledger accounts via lookup in an activity id correlation table 218, which is configured to correlate an activity account 450 with at least one general ledger account 113 115 from the at least one general ledger

In another related embodiment, the method for enterprise performance management 700, can further include:
processing the account calculation procedure 419, such that updates of the planned cost 456 of the specific activity account 410 automatically update planned cost 456 of interconnected activity accounts that are configured in an activity id connectivity table 220 in relation to the activity id number 411;
   wherein the activity id connectivity table 220 for each specific activity account 410 is configured to correlate the specific activity account 410 with an associated contra activity account 416 and an associated cross charge account 418.

Conventionally, business organizations deploy a table of unique numbering and naming conventions in a Chart of Accounts that originates in an accounting system. The accounts are used to segregate and accumulate accounting transactions that comprise activities that occur during the performance of economic activity.

Organizations operating in a single industry engage in substantially similar activities as other organizations in the same industry. In various embodiments, the system for enterprise performance management 100 can be configured to store organizational planning data in a multidimensional dataset using an aggregated chart of accounts for describing activities of a plurality of organizations operating within a specific industry or set of industries. The system for enterprise performance management 100 can be configured to use a multidimensional dataset with embedded intelligence about every account included in a chart of accounts to use for calculating activity within single accounts and between multiple accounts for activity in both in the data for the system for enterprise performance management 100 and for accounting data developed in an accounting software system 110, also referred to as an enterprise resource planning (ERP) system 110.

In a related embodiment, the system for enterprise performance management 100 can be directed to techniques of entering and presenting data in Industry centric enterprise planning and performance management (EPM) systems that improves the efficiency, accuracy and predictability of budgeting, forecasting and reporting within all organizations performing substantially similar economic activity as other organizations operating in the same industry by enabling organizations to develop and update models more quickly and frequently using Business Activity codes for describing the accounting purpose of every account included in any accounting system general ledger chart of accounts used by accounting system operators to segregate and aggregate economic activity.

In a further related embodiment, each pre-defined Business Activity code and corresponding general ledger account from an organization's accounting system chart of accounts can be incorporated into an underlying multidimensional dataset for calculating periodic budget and forecast activity including net account activity, account increase activity included in net activity and account decrease activity included in net activity and the effect each activity has upon another account or upon multiple accounts.

In a further related embodiment, the system for enterprise performance management 100 facilitates the capture and entry of data into an underlying multidimensional dataset through forms targeting separate types of business activity. In accordance with the techniques, an EPM software system stores enterprise planning data in a multidimensional dataset. Furthermore, the techniques allow analysts to use targeted business activity forms to enter data into the multidimensional dataset. The data can represent typical business activities of the enterprise. Because these business activity forms are specific to individual types of activities that contributors perform, the business activity forms may be easier for the contributors to use than general ledger type forms.

Furthermore, in another further related embodiment, the system for enterprise performance management 100 can automatically calculate activity for interrelated accounts using high level business data captured and entered into an underlying multidimensional dataset.

Further still, in yet another further related embodiment, the system for enterprise performance management 100 can allow department of finance managers to apply identical allocation methodology to data in the system for enterprise performance management 100 and data from an accounting software system 110 for developing comparable comprehensive internal organizational data for operators and department of finance managers to use to compare and analyzing outcomes from both systems.

In yet another further related embodiment, in accordance with the techniques the system for enterprise performance management 100 can allow department of finance managers to apply identical methodology for developing cross-charges data for target activity from and between separate internal organizations, outside locations, subsidiaries and parent organizations in both the system for enterprise performance management 100 and data from an accounting software system.

In a related embodiment, the system for enterprise performance management 100 can integrate intelligence about the accounting use of every general Ledger Account for any organization operating in a single industry and uses that information for creating database routines and calculations that determine the activity in every account or accounts that is impacted by a change in another account or accounts and eliminates operator activity that is otherwise required to determine outcomes.

In a further related embodiment, the system for enterprise performance management 100 can use the information about the accounting use of every account to segregate and display information in groups of data that contain common characteristics for fast and simple operator input and for separating high value activity from low value activity for accommodating targeted updates to data deemed to be most relevant by the operator when implementing the system.

In a further related embodiment, the system for enterprise performance management 100 introduces industry specific uniform tables of activity id codes, contra activity codes and summary Activity id Codes designed to define all activities described by all general ledger chart of accounts for multiple target industries to use for automating budgeting, forecasting and reporting account activity, interconnected account activity, departments, locations and subsidiaries, cross charges for shared services and for syncing allocation methodology between budgeting, forecasting and results originating from an organization's accounting system.

In another related embodiment, activity id codes can be created for describing the accounting purpose of all general ledger accounts for every organization operating in a target industry.

In yet a related embodiment, activity ids can be used to aggregate General Ledger Accounts with Accounting Purposes that include unique characteristics including
a) One-to-One single use, such as for example to denote a cash primary account;
b) One-to-One with a single contra account, such as for example inventory::cost of sales inventory relief;
c) One-to-One with multiple Contra Accounts, such as for example accounts receivable::sales accounts; and/or
d) One to Many: (i.e. Other Expense)

In a related embodiment, every general ledger 113 account from each industry specific organization can be mapped to an activity id 430 that is used to identify the specific accounting purpose of each account and present an aggregated summary and planning view. Thereby, activity id intelligence that is encoded in the activity id correlation table 218 and the activity id connectivity table 220, as discussed in detail below, can be used to calculate activity specific to planning account activities.

In a related embodiment, activity id codes assigned to each one of the target organization's general Ledger chart of accounts can be used for automating database routines and calculations for improving efficiency and accuracy of calculations used for deriving the effect that net activity or the component of net activity that increases or decreases the activity in either a single account or group of accounts has upon another account or accounts.

In other related embodiments, planning, budgeting and forecasting requires an analysis of general ledger accounts used by the accounting system to segregate, accumulate and record transactions entered into by the organization. Account activity is unique to each account and is determined in part by the effect that a change in any account has upon any other account or accounts. For example, charges to third parties (i.e. Sales) has an effect on other accounts, including Accounts Receivable and Cash.

No two organizations can be assumed to have identical General Ledger Account List. Numbering and naming conventions used for accounting system 110 general ledger accounts are unique to each organization. Budget and forecasting system operators are required to calculate the effect that account activity in any one account has on one or more other accounts to determine data elements for updating budget and forecast data because existing solutions do not contain the required built in account intelligence required to analyze data for individual accounts.

For example, industries with member organizations that use balance sheet liability accounts to defer sales of products or services prior to recognizing periodic income use organization specific intelligence about the accounting use of the accounts in their unique chart of accounts to determine what accounts to update for calculated activity over multiple future periods to predict outcomes that are consistent with accounting treatment of actual activity in the same accounts.

Examples of Accounts impacted by a sale that is deferred prior to recognition of periodic income include Accounts Receivable, Cash, Sales Renewals, Deferred Revenue, Revenue Recognized, Employee Sales Incentives, Payroll Taxes with Annual Maximums, Payroll Tax with no Annual Maximum and Employee contributions to Retirement Accounts.

In related embodiments, using automation to calculate the impact from continuously changing budget and forecasting activity saves time and reduces resource requirements. The system for enterprise performance management 100 significantly increases the volume of budget and planning activity that can be completed in a shorter period of time.

In various related embodiments, the system for enterprise performance management 100 can be used in a manufacturing environment, wherein considerations impacting the timing of ordering inventory items to use in the manufacturing process can include:
a) Items required for current sales orders received from customers (can be measured);
b) Items required for future sales orders (forecasted)
c) Items Currently in Inventory (can be measured);
d) Purchase order lead time, i.e. the time it takes to receive items after placing an order with a supplier (can be measured);
e) Time to complete an order from customer—Finished Goods;
f) Product Types:
   i. The Manufacture of multiple Product Types with different mixes of Inventory Items deplete Inventory Items at different rates; and
g) The value of accurate Sales Estimates:
   i. Actual sales estimates less that forecast results in excess inventory and inefficient working capital management; and
   ii. Actual sales estimates greater than forecast results in inventory item shortages that risk idling of manufacturing processes and delayed order fulfillment;

In related embodiments, use of the system for enterprise performance management 100B can provide accurate Sales Forecasting & Inventory Levels, such that Activity ID 410 links sales activity by product type and inventory levels by matching usage of inventory items to sales totals. For example, if a company maintains multiple inventory accounts used for manufacturing multiple products, then:
a) For every Update to Sales Recorded in the Accounting System (ERP) And For Every Updated Sales Forecast in the Planning Software (FP&A),
   The Activity ID will:
      i. update the Forecasted dollar amount for the Inventory Balances; and
      ii. update the Forecasted quantities for Inventory Items.

In other related embodiments, in relation to sales orders:
a) When a user enters a Sales Order into an ERP Software 112, 114 a Work Order is created for the Bill of Materials (BOM) that includes specific Inventory Items to be consumed in the manufacture of each Product on in the Sales Order.
b) The Inventory Items in each BOM are removed from available inventory, or reserved, to accurately reflect available Items remaining in Inventory to be used to manufacture new Sales Orders.

In further related embodiments, Sales Orders impact Inventory levels. Sales Orders entered into the ERP 112, 114 can include amounts for:
a) The Cost of Items Consumed in the Manufacture Process;
b) A Mark-up Amount for Labor, Overhead; and
c) Profit Margin.

In a related embodiment, Forecast Models use updated ERP 112, 114 Sales data for calculating Inventory Item levels at the beginning of the Forecast Period to accurately predict Item usage and re-ordering requirements for future periods.

In another related embodiment, ERP 112, 114 reporting data includes beginning balance, net increase/decrease and ending balance Sales, Cost of Sales and Inventory.

In yet a related embodiment, to update a Forecast Model for ERP 112, 114 results a user must derive Sales details not found in ERP summary results and analyze detail ledger activity to derive the inventory items reserved and available component of total Sales Orders to calculate available Inventory Items at the beginning of the Forecast Period.

In yet another related embodiment, the system for enterprise performance management 100B can use algorithms to derive Sales, Cost of Sales and Inventory data from ERP GL Account balances and activity for calculating up to date Inventory levels for updating forecast models.

In a related embodiment, the system for enterprise performance management 100B can use algorithms to calculate Sales, Cost of Sales and Inventory balances and activity applying BOM, Labor, Overhead and Profit Margin metrics to Sales Predictions from CRM database reports.

In a related embodiment, the system for enterprise performance management 100B can predict Inventory Levels using real-time ERP Sales and Inventory balances data extracted using algorithms for identifying offsetting and related activities from raw data stored in ERP ledgers. (predictions are better when they begin with up-to date data)

In another related embodiment, the system for enterprise performance management 100B can predict Inventory Requirements using algorithms to calculate Offsetting and Interrelated GL Account activity within Sales and Inventory GL Account balances and activities.

In related embodiments, GL 112, 114 Inventory Usage varies by Product (GL Account) and Type (no GL Account). In in relation to automotive vehicles for example:
a) GL Accounts can include Product Sales (i.e. Account 40010=BMW (TM) 3 Series Coupe; Account 40020=Sedan . . . );
b) Product variations can describe Product Types (i.e. luxury, sport, Comfort Types . . . );
c) Each Product Type uses different components—(i.e. sports seats, automatic transmission, 19″ wheels);
d) Sales Organizations provide users with Sales Predictions by Product;
e) Users Predict Inventory requirements using Sales predictions by Sales Type;
f) Activity ID predicts Item requirements using algorithms to calculate item requirements by product; and
g) Activity ID also identifies the likely distribution of Product Types by Product and uses algorithms to predict Item Usage and Levels.

In a related embodiment, as shown in FIGS. 1A and 4C, a manufacturing activity account 450 in the plurality of activity accounts 450, can include a manufacturing planning activity id 452 for a manufacturing input component 142 used in manufacturing by a first factory 132 and a second factory 134, associated with respectively a first accounting system 112 and a second accounting system 114;

wherein the manufacturing activity account 450 can include a manufacturing aggregated forecasted quantity 459 for the manufacturing input component 142;
such that the enterprise performance management server 102 is configured to order the manufacturing aggregated forecasted quantity 459 of the manufacturing input component 142 via an inventory procurement system 140, such that the manufacturing aggregated forecasted quantity 459 of the manufacturing input component 142 can be distributed to the first factory 132 and the second factory 134.

Thus, in an embodiment, as shown in FIGS. 1A, 2, 4A, 4B, 4C, and 4D, a system for enterprise manufacturing inventory management 100A, can include:
a) an enterprise performance management server 102, including a planning account overview table 222, which specifies an aggregated chart of accounts 222; wherein the planning account overview table 222 comprises a plurality of activity accounts 450, each activity account comprising:
   a planning activity id 452, comprising:
      a planning activity id number 453; and
      a planning activity id description 454;
   an aggregated planned cost 456;
   an aggregated actual cost 458; and
   an aggregated forecasted quantity 459;
b) an enterprise performance management device 104;
c) a plurality of accounting systems, comprising: a first accounting system 112, comprising a first general ledger 113, and a second accounting system 114, comprising a second general ledger 115;
   wherein the first general ledger 113 and the second general ledger 115 are different (such as with a different chart of account structure and/or with different account ids/names), wherein general ledger accounts 470 in the first general ledger 113 and general ledger accounts 470 in the second general ledger 115 are different; and
d) an inventory procurement system 140, for managing and procuring inventory 142 for use in manufacturing;
wherein the enterprise performance management server 102, further comprises:
   i. an activity id connectivity table 220, which for each specific activity account 450 is configured to correlate the specific activity account 450 with an associated contra activity account 416, an associated cross charge account 418, and an associated account calculation procedure 419; and
   ii. account planning manager instructions 212, which are configured to process the associated account calculation procedure 419, wherein the account planning manager instructions 212 process updates of the aggregated planned cost 456 of the specific activity account 450 to automatically update aggregated planned cost 456 of interconnected activity accounts 450 that are configured in the activity id connectivity table 220 in relation to the specific activity account 450;
wherein the enterprise performance management server is configured to aggregate general ledger accounts 470 from the first general ledger 113 and the second general ledger 115, wherein the enterprise performance management server 102 creates, stores, and processes the aggregated chart of accounts 222, comprising activity accounts 450, each comprising the planning activity id 452, which is associated with the aggregated planned cost 456, the aggregated actual cost 458, and the aggregated forecasted quantity 459, which aggregate respectively general ledger planned costs 476, general ledger actual costs 478, and general ledger forecasted quantities 479 of the general ledger accounts 470,
such that the aggregated chart of accounts 222 aggregates the general ledger accounts 470 from the first general ledger 113 and the second general ledger 115;
wherein the enterprise performance management server, further comprises:
   a first processor 202;
   a first non-transitory memory 204;
   a first input/output component 206;
   an activity id correlation table 218, which is configured to correlate an activity account 450 with general ledger accounts 470 of the first general ledger 113 and the second general ledger 115; and
   account aggregation manager instructions 210, which are configured to update the planning account overview table 222 with aggregated information from the first general ledger 113 and the second general ledger 115, wherein for the activity account 450, the account aggregation manager instructions 210 aggregate the aggregated actual cost 456, the aggregated planned cost 456, and the aggregated forecasted quantity 459 from correlated general ledger accounts 436 via lookup in the activity id correlation table 218; all connected via
   a first data bus 230;
wherein a manufacturing activity account 450 in the plurality of activity accounts 450, comprises a manufacturing planning activity id 452 for a manufacturing input component 142 used in manufacturing by a first factory 132 and a second factory 134, associated with respectively the first accounting system 112 and the second accounting system 114;
wherein the manufacturing activity account 450 comprises a manufacturing aggregated forecasted quantity 459 for the manufacturing input component 142;
such that the enterprise performance management server 102 is configured to order the manufacturing aggregated forecasted quantity 459 of the manufacturing input component 142 via the inventory procurement system 140, such that the manufacturing aggregated forecasted quantity 459 of the manufacturing input component 142 is distributed to the first factory 132 and the second factory 134.

In a related embodiment, the manufacturing input component 142 is distributed to the first factory 132 and the second factory 134, such that a first general ledger quantity 479 of a correlated general ledger account 470 of the first general ledger 113 is sent to the first factory 132, and such that a second general ledger quantity 479 of a correlated general ledger account 470 of the second general ledger 115 is sent to the second factory 132. Logistically, such quantities may be centrally distributed, or this may happen decentrally, such as via drop shipping, potentially from separate locations and/or vendors.

In other related embodiments, the general ledger forecasted quantity 479 of a general ledger account 470 can be forecasted according to conventional methods of forecasting, which can include qualitative and quantitative methods, time series methods, linear and non-linear projection, machine learning, and other artificial intelligence methods. Each accounting system 112, 114 may use different forecasting methods.

In another related embodiment, the first factory 132 and the second factory 134 can include respectively a first manufacturing facility 122 and a second manufacturing facility 124, which each use the manufacturing input component 142 for manufacturing.

In a related embodiment, the inventory procurement system 140 can be an integral part of the enterprise performance management server 102, or as shown in FIG. 1B, the inventory procurement system 140 can be a separate system.

In another embodiment, as shown in FIGS. 1A, 2, 4A, 4B, 4C, and 4D, a system for enterprise manufacturing inventory management, can include:
a) a plurality of accounting systems 110, including:
   a first accounting system 112, including a first general ledger 113, and
   a second accounting system 114, including a second general ledger 115;
   wherein the first general ledger 113 and the second general ledger 115 are different, wherein at least some general ledger accounts 470 in the first general ledger 113 and at least some general ledger accounts 470 in the second general ledger 115 are different;
b) an enterprise performance management server 102, comprising:
   a first processor 202;
   a planning account overview table 222, which specifies an aggregated chart of accounts 222; wherein the planning account overview table 222 comprises a plurality of activity accounts 450, each activity account comprising:
      a planning activity id 452, comprising:
         a planning activity id number 453; and
         a planning activity id description 454;
      an aggregated planned cost 456;
      an aggregated actual cost 458; and
      an aggregated forecasted quantity 459;
   an activity id connectivity table 220, which for each specific activity account 450 is configured to correlate the specific activity account 450 with an associated contra activity account 416, an associated cross charge account 418, and an associated account calculation procedure 419; and
   account planning manager instructions 212, which are configured to process the associated account calculation procedure 419, wherein the account planning manager instructions 212 process updates of the aggregated planned cost 456 of the specific activity account 450 to automatically update aggregated planned cost 456 of interconnected activity accounts 450 that are configured in the activity id connectivity table 220 in relation to the specific activity account 450;
   an activity id correlation table 218, which is configured to correlate an activity account 450 with general ledger accounts 470 of the first general ledger 113 and the second general ledger 115; and
   account aggregation manager instructions 210, which are configured to update the planning account overview table 222 with aggregated information from the first general ledger 113 and the second general ledger 115, such that the account aggregation manager instructions 210 process the aggregated chart of accounts 222, comprising the activity accounts 450, each comprising the planning activity id 452, which is associated with the aggregated planned cost 456, the aggregated actual cost 458, and the aggregated forecasted quantity 459, by aggregating respectively general ledger planned costs 476, general ledger actual costs 478, and general ledger forecasted quantities 479 for correlated general ledger accounts 470 via lookup in the activity id correlation table 218; such that the aggregated chart of accounts 222 aggregates the general ledger accounts 470 from the first general ledger 113 and the second general ledger 115; all connected via
   a data bus;
wherein a manufacturing activity account 450 in the plurality of activity accounts 450, comprises a manufacturing planning activity id 452 for a manufacturing input component 142 used in manufacturing by a first factory 132 and a second factory 134, associated with respectively the first accounting system 113 and the second accounting system 115;
wherein the manufacturing activity account 450 comprises a manufacturing aggregated forecasted quantity 459 for the manufacturing input component 142;
such that the enterprise performance management server 102 is configured to order the manufacturing aggregated forecasted quantity 459 of the manufacturing input component 142 via an inventory procurement system 140, such that the manufacturing aggregated forecasted quantity 459 of the manufacturing input component 142 is distributed to the first factory 132 and the second factory 134.

It shall be understood that an executing instance of an embodiment of the system for enterprise manufacturing inventory management 100A, as shown in FIG. 1A, can include a plurality of enterprise performance management devices 104, which are each tied to one or more users 160.

Similarly, an executing instance of an embodiment of the system for enterprise performance management 100B, as shown in FIG. 1B, can include a plurality of enterprise performance management devices 104, which are each tied to one or more users 160.

An executing instance of an embodiment of the system for enterprise manufacturing inventory management 100A, as shown in FIG. 1A, can similarly include a plurality of enterprise performance management servers 102.

Similarly, an executing instance of an embodiment of the system for enterprise performance management 100B, as shown in FIG. 1B, can include a plurality of enterprise performance management servers 102.

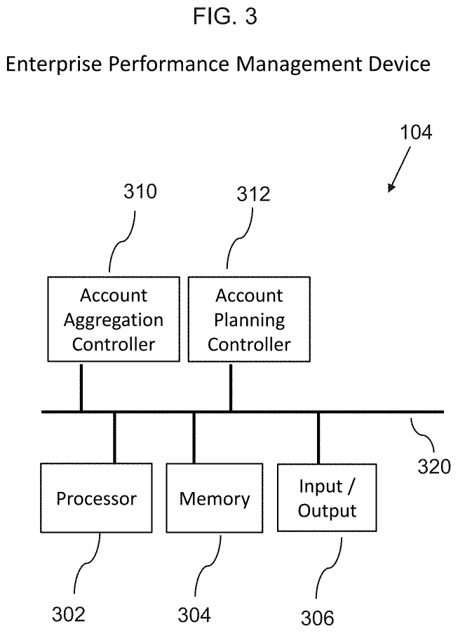

FIGS. 1A, 1B, 2, 3, 5A-K, 6A-6D, and 7 are block diagrams and flowcharts, methods, devices, systems, apparatuses, and computer program products according to various embodiments of the present invention. It shall be understood that each block or step of the block diagram, flowchart and control flow illustrations, and combinations of blocks in the block diagram, flowchart and control flow illustrations, can be implemented by computer program instructions or other means. Although computer program instructions are discussed, an apparatus or system according to the present invention can include other means, such as hardware or some combination of hardware and software, including one or more processors or controllers, for performing the disclosed functions.

In this regard, FIGS. 1A, 1B, 2, and 3 depict the computer devices of various embodiments, each containing several of the key components of a general-purpose computer by which an embodiment of the present invention may be implemented. Those of ordinary skill in the art will appreciate that a computer can include many components. However, it is not necessary that all of these generally conventional components be shown in order to disclose an illustrative embodiment for practicing the invention. The general-purpose computer can include a processing unit and a system memory, which may include various forms of non-transitory storage media such as random access memory (RAM) and read-only memory (ROM). The computer also may include nonvolatile storage memory, such as a hard disk drive, where additional data can be stored.

FIGS. 1A and 1B, show a depiction of embodiments of the system for enterprise manufacturing inventory management 100A and the system for enterprise performance management 100B, respectively, each including the enterprise performance management server 102 and the enterprise performance management device 104. In this relation, a server shall be understood to represent a general computing capability that can be physically manifested as one, two, or a plurality of individual physical computing devices, located at one or several physical locations. A server can for example be manifested as a shared computational use of one single desktop computer, a dedicated server, a cluster of rack-mounted physical servers, a datacenter, or network of datacenters, each such datacenter containing a plurality of physical servers, or a computing cloud, such as Amazon EC2 or Microsoft Azure.

It shall be understood that the above-mentioned components of the enterprise performance management server 102 and the enterprise performance management device 104 are to be interpreted in the most general manner.

For example, the processors 202 302, can each respectively include a single physical microprocessor or microcontroller, a cluster of processors, a datacenter or a cluster of datacenters, a computing cloud service, and the like.

In a further example, the non-transitory memory 204 and the non-transitory memory 304 can each respectively include various forms of non-transitory storage media, including random access memory and other forms of dynamic storage, and hard disks, hard disk clusters, cloud storage services, and other forms of long-term storage. Similarly, the input/output 206 and the input/output 306 can each respectively include a plurality of well-known input/output devices, such as screens, keyboards, pointing devices, motion trackers, communication ports, and so forth.

Furthermore, it shall be understood that the enterprise performance management server 102 and the enterprise performance management device 104 can each respectively include a number of other components that are well known in the art of general computer devices, and therefore shall not be further described herein. This can include system access to common functions and hardware, such as for example via operating system layers such as Windows, Linux, and similar operating system software, but can also include configurations wherein application services are executing directly on server hardware or via a hardware abstraction layer other than a complete operating system.

An embodiment of the present invention can also include one or more input or output components, such as a mouse, keyboard, monitor, and the like. A display can be provided for viewing text and graphical data, as well as a user interface to allow a user to request specific operations. Furthermore, an embodiment of the present invention may be connected to one or more remote computers via a network interface. The connection may be over a local area network (LAN) wide area network (WAN), and can include all of the necessary circuitry for such a connection.

In a related embodiment, the enterprise performance management device 104 communicates with the enterprise performance management server 102 over a network, which can include the general Internet, a Wide Area Network or a Local Area Network, or another form of communication network, transmitted on wired or wireless connections. Wireless networks can for example include Ethernet, Wi-Fi, Bluetooth, ZigBee, and NFC. The communication can be transferred via a secure, encrypted communication protocol.

Typically, computer program instructions may be loaded onto the computer or other general-purpose programmable machine to produce a specialized machine, such that the instructions that execute on the computer or other programmable machine create means for implementing the functions specified in the block diagrams, schematic diagrams or flowcharts. Such computer program instructions may also be stored in a computer-readable medium that when loaded into a computer or other programmable machine can direct the machine to function in a particular manner, such that the instructions stored in the computer-readable medium produce an article of manufacture including instruction means that implement the function specified in the block diagrams, schematic diagrams or flowcharts.

In addition, the computer program instructions may be loaded into a computer or other programmable machine to cause a series of operational steps to be performed by the computer or other programmable machine to produce a computer-implemented process, such that the instructions that execute on the computer or other programmable machine provide steps for implementing the functions specified in the block diagram, schematic diagram, flowchart block or step.

Accordingly, blocks or steps of the block diagram, flowchart or control flow illustrations support combinations of means for performing the specified functions, combinations of steps for performing the specified functions and program instruction means for performing the specified functions. It will also be understood that each block or step of the block diagrams, schematic diagrams or flowcharts, as well as combinations of blocks or steps, can be implemented by special purpose hardware-based computer systems, or combinations of special purpose hardware and computer instructions, that perform the specified functions or steps.

As an example, provided for purposes of illustration only, a data input software tool of a search engine application can be a representative means for receiving a query including one or more search terms. Similar software tools of applications, or implementations of embodiments of the present invention, can be means for performing the specified functions. For example, an embodiment of the present invention may include computer software for interfacing a processing element with a user-controlled input device, such as a mouse, keyboard, touch screen display, scanner, or the like. Similarly, an output of an embodiment of the present invention may include, for example, a combination of display software, video card hardware, and display hardware. A processing element may include, for example, a controller or microprocessor, such as a central processing unit (CPU), arithmetic logic unit (ALU), or control unit.

Here has thus been described a multitude of embodiments of the enterprise performance management system 100, devices, and methods related thereto, which can be employed in numerous modes of usage.

The many features and advantages of the invention are apparent from the detailed specification, and thus, it is intended by the appended claims to cover all such features and advantages of the invention, which fall within the true spirit and scope of the invention.

For example, alternative embodiments can reconfigure or combine the components of the enterprise performance management server 102 and the enterprise performance management device 104. The components of the enterprise performance management server 102 can be distributed over a plurality of physical, logical, or virtual servers. Parts or all of the components of the enterprise performance management device 104 can be configured to operate in the enterprise performance management server 102, whereby the enterprise performance management device 104 for example can function as a thin client, performing only graphical user interface presentation and input/output functions. Alternatively, parts or all of the components of the enterprise performance management server 102 can be configured to operate in the enterprise performance management device 104.

Many such alternative configurations are readily apparent, and should be considered fully included in this specification and the claims appended hereto. Accordingly, since numerous modifications and variations will readily occur to those skilled in the art, it is not desired to limit the invention to the exact construction and operation illustrated and described, and thus, all suitable modifications and equivalents may be resorted to, falling within the scope of the invention.

What is claimed is:

1. A system for enterprise manufacturing inventory management, comprising:
a) an enterprise performance management server, comprising a planning account overview table, which specifies an aggregated chart of accounts; wherein the planning account overview table comprises a plurality of activity accounts, each activity account comprising:
a planning activity id, comprising:
a planning activity id number; and
a planning activity id description;
an aggregated planned cost;
an aggregated actual cost; and
an aggregated forecasted quantity;
b) a plurality of accounting systems, comprising: a first accounting system, comprising a first general ledger, and a second accounting system, comprising a second general ledger;
wherein the first general ledger and the second general ledger are different, wherein general ledger accounts in the first general ledger and general ledger accounts in the second general ledger are different; and
c) an inventory procurement system, for managing and procuring inventory for manufacturing;
wherein the enterprise performance management server, further comprises:
an activity id connectivity table, which for each specific activity account is configured to correlate the specific activity account with an associated contra activity account, an associated cross charge account, and an associated account calculation procedure; and
account planning manager instructions, which are configured to process the associated account calculation procedure, wherein the account planning manager instructions process updates of the aggregated planned cost of the specific activity account to automatically update aggregated planned cost of interconnected activity accounts that are configured in the activity id connectivity table in relation to the specific activity account;
wherein the enterprise performance management server is configured to aggregate general ledger accounts from the first general ledger and the second general ledger, wherein the enterprise performance management server creates, stores, and processes the aggregated chart of accounts, comprising the activity accounts, each comprising the planning activity id, which is associated with the aggregated planned cost, the aggregated actual cost, and the aggregated forecasted quantity, which aggregate respectively general ledger planned costs, general ledger actual costs, and general ledger forecasted quantities of the general ledger accounts,
such that the aggregated chart of accounts aggregates the general ledger accounts from the first general ledger and the second general ledger;
wherein the enterprise performance management server, further comprises:
a first processor;
a first non-transitory memory;
a first input/output component;
an activity id correlation table, which is configured to correlate an activity account with general ledger accounts of the first general ledger and the second general ledger; and
account aggregation manager instructions, which are configured to update the planning account overview table with aggregated information from the first general ledger and the second general ledger, wherein for the activity account, the account aggregation manager instructions aggregate the aggregated actual cost, the aggregated planned cost, and the aggregated forecasted quantity from correlated general ledger accounts via lookup in the activity id correlation table; all connected via
a first data bus;
wherein a manufacturing activity account in the plurality of activity accounts, comprises a manufacturing planning activity id for a manufacturing input component used in manufacturing by a first factory and a second factory, associated with respectively the first accounting system and the second accounting system;
wherein the manufacturing activity account comprises a manufacturing aggregated forecasted quantity for the manufacturing input component;
such that the enterprise performance management server is configured to order the manufacturing aggregated forecasted quantity of the manufacturing input component via the inventory procurement system, such that the manufacturing aggregated forecasted quantity of the manufacturing input component is distributed to the first factory and the second factory.

2. The system for enterprise manufacturing inventory management of claim 1, wherein the aggregated planned cost, the aggregated actual cost, and the aggregated forecasted quantity are aggregated according to a periodic schedule, wherein the periodic schedule is specified by month, quarter, and year.

3. The system for enterprise manufacturing inventory management of claim 1, wherein the activity id correlation table comprises a plurality of correlation records, each correlation record comprising:
a) a correlation activity id, comprising:
a correlation activity id number; and
a correlation activity id description;
b) a general ledger account, which references an account in the first general ledger of the plurality of accounting systems, wherein the correlation activity id is associated with the general ledger account.

4. The system for enterprise manufacturing inventory management of claim 3, wherein each correlation record further comprises:
a business id, which indicates that the business id is associated with a business operating with the plurality of accounting systems.

5. The system for enterprise manufacturing inventory management of claim 1, wherein the activity id connectivity table comprises a plurality of connectivity records, each connectivity record comprising:
a) a connectivity activity id, comprising:
a connectivity activity id number; and
a connectivity activity id description;
b) a one-to-one flag, which is configured to indicate if the connectivity activity id has a one-to-one relationship with a corresponding general ledger account of the plurality of accounting systems;
c) a contra activity id, which is configured to indicate a second activity id for contra posting in relation to the connectivity activity id; and
d) a cross charges activity id, which is configured to indicate a third activity id for cross charging in relation to the connectivity activity id.

6. The system for enterprise manufacturing inventory management of claim 5, wherein each connectivity record in the plurality of connectivity records further comprises:
the associated account calculation procedure, which is configured to automate calculations of activity account adjustments that are a result of interconnected account relationships that are configured in the activity id connectivity table in relation to the connectivity activity id.

7. The system for enterprise manufacturing inventory management of claim 1, further comprising an enterprise performance management device, which comprises:
a) a second processor;
b) a second non-transitory memory;
c) a second input/output;
d) account aggregation controller instructions, which are configured to allow a user to view the planning account overview table in communication with the account aggregation manager instructions; and
e) account planning controller instructions, which are configured to allow a user to view and update the aggregated planned cost of the planning account overview table in communication with the account planning manager instructions; all connected via
f) a second data bus.

8. An enterprise performance management server, comprising:
a) a processor;
b) a non-transitory memory;
c) an input/output component;
d) an activity id correlation table, which is configured to correlate an activity account with general ledger accounts of a first general ledger and a second general ledger;
e) a planning account overview table, which specifies an aggregated chart of accounts, wherein the planning account overview table comprises a plurality of activity accounts;
f) account aggregation manager instructions, which are configured to update the planning account overview table with aggregated information from the first general ledger and the second general ledger, wherein for the activity account, the account aggregation manager instructions aggregate an aggregated actual cost, an aggregated planned cost, and an aggregated forecasted quantity from correlated general ledger accounts via lookup in the activity id correlation table;
g) an activity id connectivity table, which for each specific activity account is configured to correlate the specific activity account with an associated contra activity account, an associated cross charge account, and an account calculation procedure; and
h) account planning manager instructions, which are configured to process the account calculation procedure, wherein the account planning manager instructions process updates of aggregated planned cost of the specific activity account to automatically update aggregated planned cost of interconnected activity accounts that are configured in the activity id connectivity table in relation to the specific activity account; all connected via
i) a data bus;
wherein the enterprise performance management server is configured to aggregate general ledger accounts from the first general ledger and the second general ledger in a plurality of accounting systems, comprising: a first accounting system, comprising the first general ledger and a second accounting system, comprising the second general ledger, wherein the first general ledger and the second general ledger are different, wherein general ledger accounts in the first general ledger and general ledger accounts in the second general ledger are different;
wherein the enterprise performance management server creates, stores, and processes the aggregated chart of accounts, comprising activity accounts, each comprising a planning activity id, which is associated with the aggregated planned cost, the aggregated actual cost, and the aggregated forecasted quantity, which aggregate respectively general ledger planned costs, general ledger actual costs, and general ledger forecasted quantities of the general ledger accounts, such that the aggregated chart of accounts aggregates the general ledger accounts from the first general ledger and the second general ledger;
wherein a manufacturing activity account in the plurality of activity accounts, comprises a manufacturing planning activity id for a manufacturing input component used in manufacturing by a first factory and a second factory, associated with respectively the first accounting system and the second accounting system;
wherein the manufacturing activity account comprises a manufacturing aggregated forecasted quantity for the manufacturing input component;
such that the enterprise performance management server is configured to order the manufacturing aggregated forecasted quantity of the manufacturing input component via an inventory procurement system, such that the manufacturing aggregated forecasted quantity of the manufacturing input component is distributed to the first factory and the second factory.

9. The enterprise performance management server of claim 8, wherein the activity id correlation table comprises a plurality of correlation records, each correlation record comprising:
a) a correlation activity id, comprising:
a correlation activity id number; and
a correlation activity id description; and
b) a general ledger account, which references an account in the first general ledger of the plurality of accounting systems, such that the correlation activity id is associated with the general ledger account.

10. The enterprise performance management server of claim 8, wherein each activity account comprises:
a) a planning activity id, comprising:
a planning activity id number; and
a planning activity id description;
b) the aggregated planned cost;
c) the aggregated actual cost; and
d) the aggregated forecasted quantity.

11. The enterprise performance management server of claim 8, wherein the activity id connectivity table comprises a plurality of connectivity records, each connectivity record comprising:
a) a connectivity activity id, comprising:
a connectivity activity id number; and
a connectivity activity id description;
b) a contra activity id, which is configured to indicate a second activity id for contra posting in relation to the connectivity activity id; and
c) a cross charges activity id, which is configured to indicate a third activity id for cross charging in relation to the connectivity activity id.

12. The enterprise performance management server of claim 11, wherein each correlation record further comprises:
the account calculation procedure, which is configured to automate calculations of activity account adjustments that are a result of interconnected account relationships that are configured in the activity id connectivity table in relation to the connectivity activity id number.

13. A method for enterprise manufacturing inventory management, comprising:
a) creating an aggregated chart of accounts, comprising creating a planning account overview table of activity accounts, each comprising a planning activity id, an aggregated planned cost, an aggregated actual cost, and an aggregated forecasted quantity, by aggregating general ledger accounts from a plurality of general ledgers in a plurality of accounting systems;
wherein the plurality of accounting systems comprises:
a first accounting system, comprising a first general ledger; and
a second accounting system, comprising a second general ledger;
wherein the first general ledger and the second general ledger are different, wherein general ledger accounts in the first general ledger and general ledger accounts in the second general ledger are different;
b) updating planning information, comprising updating the planning account overview table with aggregated information from the first general ledger and the second general ledger, by aggregating, for each activity account, the aggregated actual cost, the aggregated planned cost, and the aggregated forecasted quantity from correlated general ledger accounts via lookup in an activity id correlation table, which is configured to correlate an activity account with the general ledger accounts from the first general ledger and the second general ledger; wherein updating planning information further comprises:
processing updates of planned cost of an activity account in the planning account overview table, to automatically update planned cost of interconnected activity accounts, which are configured in an activity id connectivity table in relation to the planning activity id of the activity account;
such that the aggregated chart of accounts aggregates the general ledger accounts from the first general ledger and the second general ledger; and
c) ordering manufacturing inventory, wherein a manufacturing activity account in the activity accounts, comprises a manufacturing planning activity id for a manufacturing input component used in manufacturing by a first factory and a second factory, associated with respectively the first accounting system and the second accounting system;
wherein the manufacturing activity account comprises a manufacturing aggregated forecasted quantity for the manufacturing input component;
such that the manufacturing aggregated forecasted quantity of the manufacturing input component is ordered via an inventory procurement system.

14. The method for enterprise manufacturing inventory management of claim 13, further comprising:
distributing the manufacturing aggregated forecasted quantity of the manufacturing input component to the first factory and the second factory.

15. The method for enterprise manufacturing inventory management of claim 13, wherein the activity id correlation table comprises a plurality of correlation records, each correlation record comprising:
a) a correlation activity id, comprising:
a correlation activity id number; and
a correlation activity id description; and
b) a general ledger account, which is an account in at least one general ledgers of the plurality of general ledgers of the plurality of accounting systems, such that the correlation activity id is associated with the general ledger account.

16. The method for enterprise manufacturing inventory management of claim 13, wherein the planning account overview table comprises a plurality of activity accounts, each activity account comprising:
a) the planning activity id, comprising:
a planning activity id number; and
a planning activity id description;
b) the aggregated planned cost;
c) the aggregated actual cost; and
d) the aggregated forecasted quantity.

17. The method for enterprise manufacturing inventory management of claim 16, further comprising:
processing an account calculation procedure, such that updates of the aggregated planned cost of a specific activity account automatically updates planned cost of interconnected activity accounts that are configured in an activity id connectivity table in relation to the planning activity id number;
wherein the activity id connectivity table for each specific activity account is configured to correlate the specific activity account with an associated contra activity account and an associated cross charge account.

18. The method for enterprise manufacturing inventory management of claim 17, wherein the activity id connectivity table comprises a plurality of connectivity records, each connectivity record comprising:
a) a connectivity activity id, comprising:
a connectivity activity id number; and
a connectivity activity id description;
b) a contra activity id, which is configured to indicate a second activity id for contra posting in relation to the connectivity activity id; and
c) a cross charges activity id, which is configured to indicate a third activity id for cross charging in relation to the connectivity activity id.

19. The method for enterprise manufacturing inventory management of claim 18, wherein each connectivity record of the plurality of connectivity records further comprises:
the account calculation procedure, which is configured to automate calculations of activity account adjustments that are a result of interconnected account relationships that are configured in the activity id connectivity table in relation to the connectivity activity id number.

20. A system for enterprise manufacturing inventory management, comprising:
c) a plurality of accounting systems, comprising:
a first accounting system, comprising a first general ledger, and
a second accounting system, comprising a second general ledger;
wherein the first general ledger and the second general ledger are different, wherein general ledger accounts in the first general ledger and general ledger accounts in the second general ledger are different;
d) an enterprise performance management server, comprising:
a first processor;
a planning account overview table, which specifies an aggregated chart of accounts; wherein the planning account overview table comprises a plurality of activity accounts, each activity account comprising:
a planning activity id, comprising:
a planning activity id number; and
a planning activity id description;
an aggregated planned cost;
an aggregated actual cost; and
an aggregated forecasted quantity;
an activity id connectivity table, which for each specific activity account is configured to correlate the specific activity account with an associated contra activity account, an associated cross charge account, and an associated account calculation procedure;
account planning manager instructions, which are configured to process the associated account calculation procedure, wherein the account planning manager instructions process updates of the aggregated planned cost of the specific activity account to automatically update aggregated planned cost of interconnected activity accounts that are configured in the activity id connectivity table in relation to the specific activity account;
an activity id correlation table, which is configured to correlate an activity account with general ledger accounts of the first general ledger and the second general ledger; and
account aggregation manager instructions, which are configured to update the planning account overview table with aggregated information from the first general ledger and the second general ledger,
such that the account aggregation manager instructions process the aggregated chart of accounts, comprising the activity accounts, each comprising the planning activity id, which is associated with the aggregated planned cost, the aggregated actual cost, and the aggregated forecasted quantity, by aggregating respectively general ledger planned costs, general ledger actual costs, and general ledger forecasted quantities for correlated general ledger accounts via lookup in the activity id correlation table;
such that the aggregated chart of accounts aggregates the general ledger accounts from the first general ledger and the second general ledger; all connected via
a data bus;
wherein a manufacturing activity account in the plurality of activity accounts, comprises a manufacturing planning activity id for a manufacturing input component used in manufacturing by a first factory and a second factory, associated with respectively the first accounting system and the second accounting system;
wherein the manufacturing activity account comprises a manufacturing aggregated forecasted quantity for the manufacturing input component;
such that the enterprise performance management server is configured to order the manufacturing aggregated forecasted quantity of the manufacturing input component via an inventory procurement system, such that the manufacturing aggregated forecasted quantity of the manufacturing input component is distributed to the first factory and the second factory.
